(19) United States
(12) Patent Application Publication
(10) Pub. No.: US 2025/0315223 A1
(43) Pub. Date: Oct. 9, 2025

(54) SYSTEMS, METHODS, AND USER INTERFACES FOR GENERATING INHERENTLY SOUND CODE

(71) Applicant: Nectry, Inc., Cambridge, MA (US)

(72) Inventors: Adam James Chlipala, Cambridge, MA (US); Daniel Thomas Winograd-Cort, Southbury, CT (US); Diou Shi, Sudbury, MA (US)

(21) Appl. No.: 18/806,460

(22) Filed: Aug. 15, 2024

Related U.S. Application Data
(60) Provisional application No. 63/631,779, filed on Apr. 9, 2024.

(51) Int. Cl. G06F 8/36

(52) U.S. Cl. CPC G06F 8/36

(57) ABSTRACT

The various implementations described herein include methods and systems for generating applications and programs. In one aspect, a method of application generation includes presenting a user interface configured to assist a user with creating an application. The method also includes receiving, via the user interface, an indication of a set of components in a specification language and corresponding inputs, and generating, using the set of components and the corresponding inputs, code in a programming language, the code implementing the application. The method further includes presenting, via the user interface, at least a portion of the application.

### CROSS-REFERENCE TO RELATED APPLICATIONS

This application claims priority to U.S. Application Ser. No. 63/631,779, filed on Apr. 9, 2024 and entitled “Systems, Methods, and User Interfaces for Generating Inherently Sound Code,” which is hereby incorporated by reference in its entirety.

### TECHNICAL FIELD

The disclosed embodiments relate generally to generating code, including but not limited to, systems and methods for generating inherently sound code.

### BACKGROUND

Traditional programming languages allow programmers to make mistakes that lead to incorrect results and/or security vulnerabilities. Even the advent of modern integrated development environments (IDEs) which may employ auto-completion or generative artificial intelligence (AI) code generation has not solved this problem as the generated code can still be incorrect and/or contain security vulnerabilities. Thus, the security and reliability of applications remain a challenge.

Historically, some programming languages were developed to ensure formal program verification, but they require significantly more time to develop programs because they place a great burden on the software engineer to write assertions and rigorously define objects, methods, and components. Even experienced software engineers struggle with these tasks.

More recently there has been a need for non-software engineers, sometimes known as citizen developers, to create new business applications. Low-code and no-code platforms can assist citizen developers in creating such applications. However, low-code platforms still require users to read, understand, and write code, which can be problematic for those without software engineering expertise. Additionally, traditional no-code platforms typically offer visual interfaces with drag-and-drop positioning of pre-built components. They employ data abstraction and encapsulation to remove the need for users to read, understand, or write code. However, such no-code platforms lack the capability to ensure formal program verification, guaranteeing correctness, and the absence of security vulnerabilities in the generated code. Additionally, users of no-code platforms may find it challenging to choose the correct components and to properly position and configure them without assistance.

### SUMMARY

Accordingly, there is a need for a platform/system for application development that allows business domain experts with no software engineering experience to create new business applications without having to read, understand, or write code. Moreover, there is a need for a platform/system that employs formal program verification techniques to ensure that the new business applications are correct (e.g., free of failure points, logical inconsistencies, and/or other flaws), efficient, and secure.

The present disclosure describes platforms (e.g., systems and devices) that function at an elevated conceptual layer (e.g., rather than consisting of low-level user-interface elements like drop-down menus and checkboxes). The platforms described herein can encapsulate and execute well-defined business operations and workflows.

In accordance with some embodiments, a method of application generation is performed at a computing system (e.g., an electronic device or distributed computing system). The method includes: (i) obtaining a list of application components (e.g., from a library of components for use in generating applications), including obtaining input and output type information (e.g., type information such as integer, string, float, date, etc.) for each application component of the list of application components; (ii) receiving a natural language input from a user, the natural language input indicating a user-specified functionality for an application (e.g., the natural language input is associated with a plurality of user requested application features); (iii) in response to the natural language input from the user, automatically: (a) generating a first prompt for a generative artificial intelligence (AI) component based on the natural language input, the first prompt requesting that the generative AI component select an appropriate set of application components from the list of application components; (b) obtaining a first response to the first prompt from the generative AI component; (c) generating a second prompt for the generative AI component based on the natural language input and the response to the first prompt; and (d) obtaining a second response from the generative AI component, the second response responsive to the second prompt; (iv) presenting to the user a recommendation for implementing the user-specified functionality, based on the first response and the second response, from the generative AI component; and (v) in response to receiving an acceptance of the recommendation, generating code in a (e.g., functional) programming language based on the first response and the second response from the generative AI component, wherein the code implements the user-specified functionality. In various embodiments, different numbers of prompts are generated for the AI component (e.g., 1, 3, 5, or other number). In some embodiments, the number of generated prompts is based on a dynamic decision tree.

In accordance with some embodiments, a method of application generation is performed at a computing system (e.g., an electronic device or a distributed computing system). The method includes: (i) presenting a user interface configured to assist a user with creating an application; (ii) receiving, via the user interface, an indication of a set of components in a specification language and corresponding inputs (e.g., configuration settings); (iii) generating, using the set of components and the corresponding inputs, code in a (e.g., functional) programming language, the code implementing the application; and (iv) presenting, via the user interface, at least a portion of the application.

In some embodiments, a computing system includes one or more electronic devices. In some embodiments, an electronic device includes one or more processors and memory storing one or more programs; the one or more programs configured to be executed by the one or more processors. In some embodiments, the one or more programs include instructions for performing or causing performance of the operations of any of the methods described herein. In accordance with some embodiments, a computer readable storage medium has stored therein instructions that, when executed by a computing system cause the system to perform or cause performance of the operations of any of the methods described herein.

Thus, systems and electronic devices are provided with improved methods and interfaces for generating applications and other programs, thereby increasing the effectiveness, efficiency, and user satisfaction with such systems and devices. Such methods and interfaces may complement or replace conventional methods for generating applications and other programs.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example application generation platform in accordance with some embodiments.

FIG. 2 is a block diagram illustrating an example client device in accordance with some embodiments.

FIG. 3 is a block diagram illustrating an example application development design hub in accordance with some embodiments.

FIG. 4 is a block diagram illustrating example components of an application generation platform in accordance with some embodiments.

FIG. 5 illustrates an example flow for an application generation platform in accordance with some embodiments.

FIGS. 6A-6S illustrate an example application generation process in accordance with some embodiments.

FIG. 7 is a flow diagram illustrating an example method of application generation in accordance with some embodiments.

FIG. 8 is a flow diagram illustrating another example method of application generation in accordance with some embodiments.

In accordance with common practice, the various features illustrated in the drawings are not necessarily drawn to scale, and like reference numerals can be used to denote like features throughout the specification and figures.

### DESCRIPTION OF EMBODIMENTS

The present disclosure describes, among other things, a system for application generation based on an underlying functional programming language with an expressive type system, but with certain elements of the language removed to facilitate rapid and correct program verification and to simplify the analysis of a generated system to determine information flow. The disclosed systems for application development ensure that the information flow complies with specified industry and/or enterprise data and security policies. The simplified language subset may be designed to enable program analysis and natural-language explanations (e.g., which traditional platforms do not provide).

The described systems for application generation can generate inherently sound code for one or more applications that enable seamless data flows between different databases, collaboration systems, enterprise resource planning (ERP) systems, and/or customer relationship management (CRM) systems. The generated applications with inherently sound code can satisfy complex enterprise level security and data compliance policies based on (i) an intuitive large language model user interface, (ii) assembling and configuring pre-built and tested components, (iii) using predetermined mathematical functions that automatically test generated code for all possible data input(s), (iv) safety features that avoid hazardous or unintended behavior, and/or (v) secure data access and authentication protocols.

In accordance with some embodiments, the system obtains information about a set of pre-generated components for application generation, including obtaining input and output type information for each component of the set of pre-generated components. A natural language input from a user is received, the natural language input indicating a user-specified functionality for an application. In response to the natural language input from the user, the system automatically (i) generates a first prompt for a generative artificial intelligence (AI) component Utility Application based on the natural language input, the first prompt requesting that the generative AI component select an appropriate set of application components from the list of application components, (ii) obtains a first response to the first prompt from the generative AI component, (iii) generates a second prompt for the generative AI component based on the natural language input and the response to the first prompt, and (iv) obtains a second response from the generative AI component, the second response responsive to the second prompt. The system presents to the user a recommendation for implementing the user-specified functionality, based on the first response and the second response, from the generative AI component, the recommendation corresponding to a subset of the set of pre-generated components. In response to receiving an acceptance of the recommendation, the system implements the user-specified functionality using the subset of the pre-generated components.

In accordance with some embodiments, the method of application generation presents a user interface configured to assist a user with creating an application, receive, via the user interface, an indication of a set of components in a specification language and corresponding inputs, and generate, using the set of components and the corresponding inputs, code in a programming language, the code implementing the application. The method further presents, via the user interface, at least a portion of the application.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

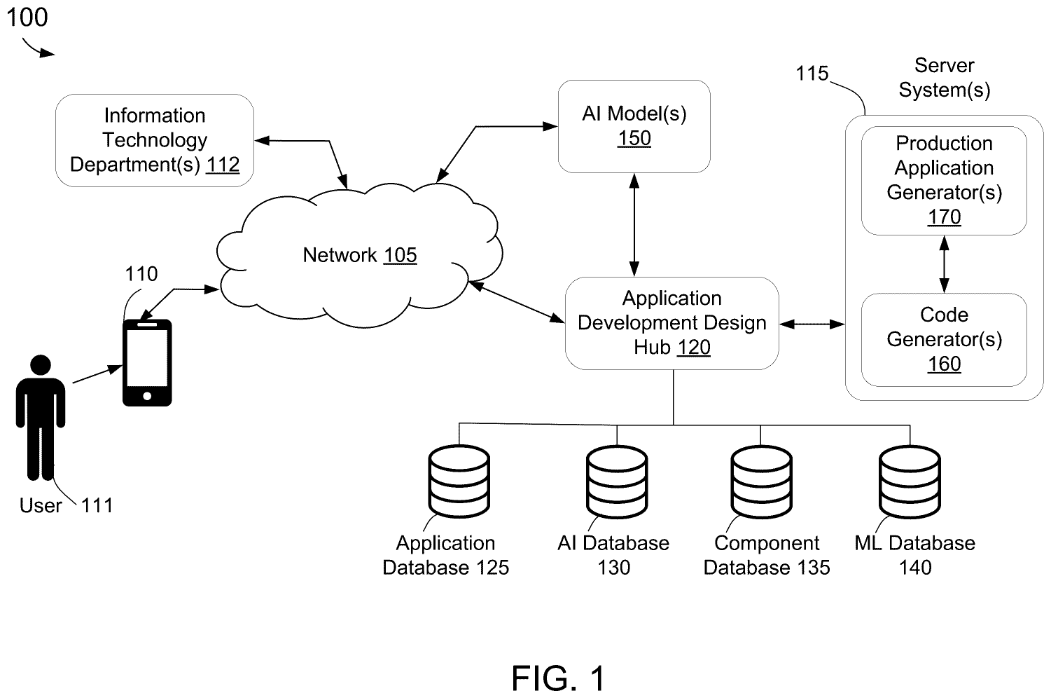

FIG. 1 is a block diagram illustrating a platform 100 in accordance with some embodiments. In some embodiments, the platform 100 is a system for application development (e.g., the system for application generation discussed previously). The platform 100 includes one or more client devices 110 communicatively coupled to an application development design hub 120 via one or more networks 105. In accordance with some embodiments, the platform 100 further includes, or communicates with, AI models 150 (e.g., generative AI models and/or other types of AI or ML models) via the one or more networks 105. In accordance with some embodiments, the platform 100 further includes, or communicates with, one or more information technology departments 112 (e.g., one or more datasets, programs, and/or user interfaces) via the one or more networks 105. In some embodiments, the application development design hub 120 communicates with one or more server system(s) 115 and/or the AI model(s) 150. In some embodiments, the application development design hub 120 further communicates with one or more databases such as an application database 125, an artificial intelligence (AI) database 130, a component database 135, and a machine learning (ML) database 140. In some embodiments, the AI database 130 and the ML database 140 are combined into a single database, or delineated in a different fashion.

In some embodiments, the server system(s) 115 includes a production application generator 170 and a code generator 160. In accordance with some embodiments, the code generator 160 is configured to generate code based on a set of inputs such as configuration files, models (e.g., data structures, classes, or entities), and predefined code structures. The code generator 160 can interpret the set of inputs, extract necessary information from the set of inputs, validate the inputs to ensure they conform to expected coding rules and formats, process the predefined code structures with actual data, and include further logic flows to generate dynamic code for the client. In some embodiments, the code generator 160 is an object-relational mapping code generator. In some embodiments, the code generator 160 is an application program interface (API) generator that creates API endpoints and client libraries. In some embodiments, the code generator 160 is a user interface component generator. In accordance with some embodiments, the production application generator 170 is a customized code generator that creates fully functional, ready-to-deploy software applications based on ensuring compatibility with different libraries, databases (e.g., AI database 130, component database 135, and ML database 140) and frameworks with automated testing, building, and deployment processes. In some embodiments, the production application generator 170 creates user guides, API documentation, and/or developer guides for the generated code. In some embodiments, the production application generator 170 includes pre-configured code structures for frontend, backend, and/or database development. In some embodiments, the production application generator 170 (or other component) ensures that the pre-configured code structures are compliant with client provided business rules, security and compliance policies, external services, external APIs, authentication modules, and/or authorization modules.

In some embodiments, the one or more networks 105 include public communication networks, private communication networks, or a combination of both public and private communication networks. For example, the one or more networks 105 can be any network (or combination of networks) such as the Internet, other wide area networks (WAN), local area networks (LAN), virtual private networks (VPN), metropolitan area networks (MAN), peer-to-peer networks, and/or ad-hoc connections. In some embodiments, the platform 100 includes only a subset of the components shown in FIG. 1. In some embodiments, the components shown in FIG. 1 are combined or otherwise delineated (e.g., the AI model(s) 150 may be a sub-component of the server system(s) 115).

In some embodiments, a client device(s) 110 is associated with one or more user(s) 111. In some embodiments, a client device 110 is a personal computer, mobile electronic device, wearable computing device, laptop computer, tablet computer, mobile phone, feature phone, smart phone, a speaker, television (TV), and/or any other electronic device capable of interacting with a user (e.g., an electronic device having an I/O interface). The client device(s) 110 may communicatively couple to other components of the platform 100 wirelessly and/or through a wired connection (e.g., directly through an interface, such as an HDMI interface).

In some embodiments, the client device(s) 110 send and receive information, such as queries, generated user interfaces, and/or personalized applications with inherently sound code, through network(s) 105. For example, the client device(s) 110 may send a query or request to the application development design hub 120, the IT department(s) 112, and/or the external database(s) 108 through network(s) 105. As another example, the client device(s) 110 may receive results and other responses from the application development design hub 120, the IT department(s) 112, and/or external database(s) through network(s) 105. In some embodiments, two or more client devices 110 communicate with one another (e.g., resending and responding to queries and requests). The two or more client devices 110 may communicate via the network(s) 105 or directly (e.g., via a wired connection or through a peer-to-peer wireless connection).

In some embodiments, the application development design hub 120 includes multiple electronic devices communicatively coupled to one another. In some embodiments, the multiple electronic devices are collocated (e.g., in a datacenter), while in other embodiments, the multiple electronic devices are geographically separated from one another. In some embodiments, the application development design hub 120 receives, sends, stores, generates, and/or provides queries, requests, pre-built functional user interface elements, LLM-based integrated development environments (IDEs) without hallucinations, scalable applications, automated data flow, etc. In some embodiments, the application development design hub 120 trains, enhances, and/or utilizes one or more agents and/or language models based on the server system(s) 115 that include the production application generator(s) 170 and the code generator(s) 160. In some embodiments, the application development design hub 120 receives and responds to queries and requests from the client device(s) 110 based on the one or more agents and/or language models. In some embodiments, the application development design hub 120 includes multiple nodes and/or clusters configured to handle different types of tasks and/or handle requests and queries from different geographical locations.

In some embodiments, the client device(s) 110 and/or the application development design hub 120 communicate with the IT department(s) 112 and/or external database(s) via an application programming interface (API). In some embodiments, the IT department(s) 112 and/or the external database(s) are maintained/operated by a third party to the platform 100. In some embodiments, the IT department(s) 112 include agents, location services, time services, web-enabled services, and/or services that access information stored external to the platform 100.

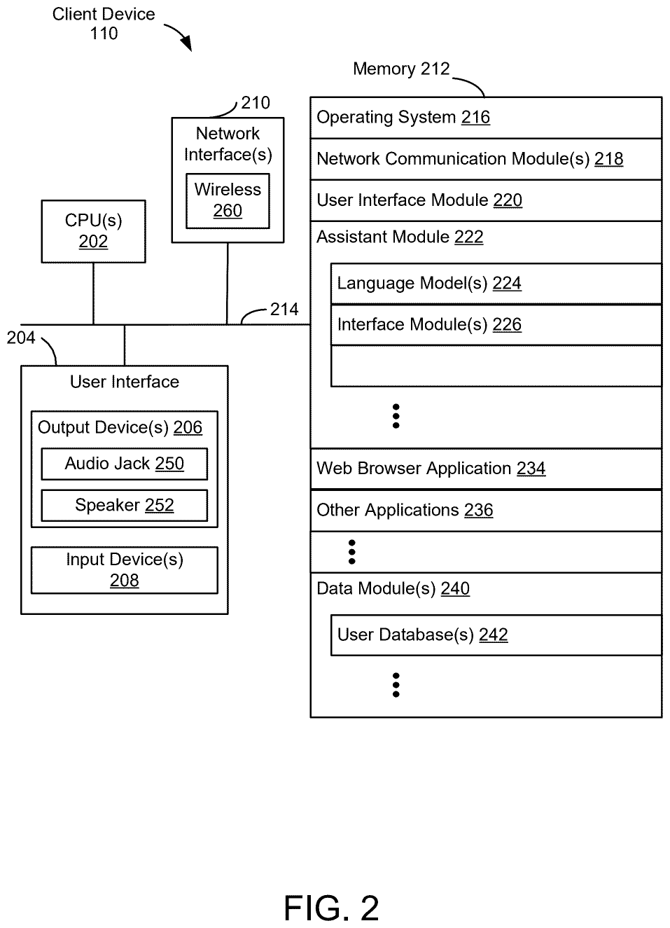

FIG. 2 is a block diagram illustrating a client device 110 in accordance with some embodiments. The client device 110 includes one or more central processing units (CPUs) 202, a user interface 204, one or more network (or other communications) interfaces 210, memory 212, and one or more communication buses 214 for interconnecting these components. In some embodiments, the client device 110 includes a processor or other control circuitry (e.g., in addition, or alternatively, to the CPUs 202), such as a graphics processing unit (GPU) or a data processing unit (DPU). The communication buses 214 optionally include circuitry (sometimes called a chipset) that interconnects and controls communications between system components. Optionally, the client device 110 includes a location-detection component, such as a global navigation satellite system (GNSS) (e.g., GPS (global positioning system), GLONASS, Galileo, BeiDou) or other geo-location receiver, and/or location-detection software for determining the location of the client device 110.

In some embodiments, client device 110 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

The user interface 204 includes output device(s) 206 and input device(s) 208. In some embodiments, the input device(s) 212 include a keyboard, mouse, a track pad, and/or a touchscreen. In some embodiments, the user interface 204 includes a display device that includes a touch-sensitive surface, in which case the display device is a touch-sensitive display. In client devices that have a touch-sensitive display, a physical keyboard is optional (e.g., a soft keyboard may be displayed when keyboard entry is needed). In some embodiments, the output device(s) 206 include an audio jack 250, a speaker 252, and/or a connection port for connecting to speakers, earphones, headphones, or other external listening devices. In some embodiments, the input device(s) 208 include a microphone and/or voice recognition device to capture audio (e.g., speech from a user).

In some embodiments, the one or more network interfaces 214 include wireless and/or wired interfaces for receiving data from and/or transmitting data to other client devices 110, the application development design hub 120, the IT department(s) 112, and/or other devices or systems. The data communications may be carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, the data communications may be carried out using any of a variety of custom or standard wired protocols (e.g., USB, Firewire, Ethernet, etc.). For example, the one or more network interfaces 210 may include a wireless interface 260 for enabling wireless data communications with other client devices 110, systems, and/or or other wireless (e.g., Bluetooth-compatible) devices. Furthermore, in some embodiments, the wireless interface 260 (or a different communications interface of the one or more network interfaces 210) enables data communications with other WLAN-compatible Utility Application devices and/or the application development design hub 120 (via the one or more network(s) 105).

The memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. The memory 212 optionally includes one or more storage devices remotely located from the CPU(s) 202. The memory 212, or alternately, the non-volatile memory solid-state storage devices within the memory 212, includes a non-transitory computer-readable storage medium. In some embodiments, the memory 212 or the non-transitory computer-readable storage medium of the memory 212 stores the following programs, modules, and data structures, or a subset or superset thereof:
an operating system 216 that includes procedures for handling various basic system services and for performing hardware-dependent tasks;
network communication module(s) 218 for connecting the client device 110 to other computing devices connected to one or more network(s) 105 via the one or more network interface(s) 214 (wired or wireless);
a user interface module 220 that receives commands and/or inputs from a user via the user interface 204 (e.g., from the input device(s) 208) and provides outputs via the user interface 204 (e.g., the output device(s) 206);
an assistant module 222 that engages with a user in an integrated, conversational manner using natural language dialog, and invokes external services when appropriate to obtain information or perform various actions. In some embodiments, the assistant module 222 works in conjunction with an application generation module at the application development design hub 120 (e.g., the application generation module 314). In some embodiments, the assistant module 222 includes the following modules (or sets of instructions), or a subset or superset thereof:
   one or more language models 224 that engage with a user and/or perform specific tasks in furtherance of a user request or query. In some embodiments, the language model(s) 224 include one or more large language models, such as GPT-3, GPT-4, GPT-4o, BioGPT, and PaLM-2; and
   an interface module 226 that allows the language model(s) 224 communicate with other applications, components, and devices (e.g., via an API or structured query);
a web browser application 234 for accessing, viewing, and interacting with web sites;
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support; and
one or more data modules 240 for handling the storage of and/or access to data such as user data, AI model(s) data, information technology department data, machine learning data, and component(s) data. In some embodiments, the one or more data modules 240 include one or more user databases 244 for storing user data such as user preferences, user settings, and other metadata.

Although FIG. 2 illustrates the client device 110 in accordance with some embodiments, FIG. 2 is intended more as a functional description of the various features that may be present in a client device than as a structural schematic of the embodiments described herein. In practice, and as recognized by those of ordinary skill in the art, items shown separately could be combined and some items could be separated.

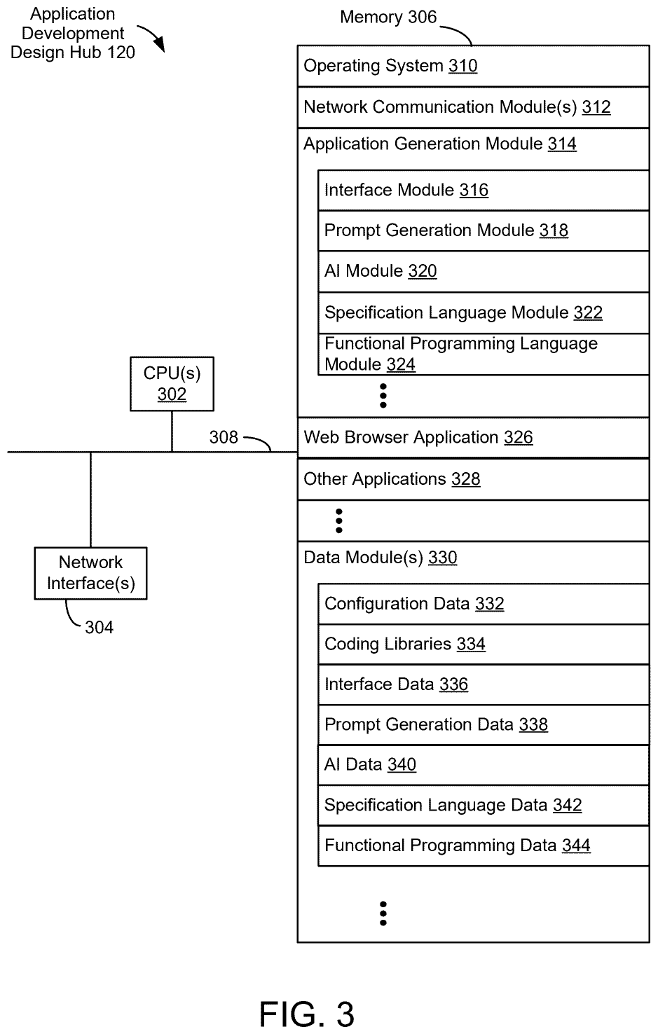

FIG. 3 is a block diagram illustrating an application development design hub 120 (e.g., a server system, distributed computing system, or other type of computing system) in accordance with some embodiments. In accordance with some embodiments, the application development design hub 120 includes one or more CPUs 302, one or more network interfaces 304, memory 306, and one or more communication buses 308 for interconnecting these components. In some embodiments, the application development design hub 120 includes a processor or other control circuitry (e.g., in addition, or alternatively, to the CPUs 202), such as a graphics processing unit (GPU) or a data processing unit (DPU), e.g., for use with AI and/or ML computations.

The memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. The memory 306 optionally includes one or more storage devices remotely located from one or more CPUs 302. The memory 306, or, alternatively, the non-volatile solid-state memory device(s) within the memory 306, includes a non-transitory computer-readable storage medium. In some embodiments, the memory 306, or the non-transitory computer-readable storage medium of the memory 306, stores the following programs, modules and data structures, or a subset or superset thereof:
an operating system 310 that includes procedures for handling various basic system services and for performing hardware-dependent tasks;
a network communication module 312 that is used for connecting the application development design hub 120 to other computing devices connected to one or more networks 105 via one or more network interfaces 304 (wired or wireless);
an application generation module 314 that engages with a user (e.g., a remote user) in an integrated, conversational manner using natural language dialog, and invokes external services when appropriate to obtain information or perform various actions. In some embodiments, the application generation module 314 works in conjunction with an assistant module at a client device 110 (e.g., the assistant module 222). In some embodiments, the application generation module 314 includes the following modules (or sets of instructions), or a subset or superset thereof:
   one or more interface modules 316 for communicating with users, other agents, applications, components, and/or devices (e.g., via an API or structured query);
   one or more prompt generation modules 318 for generating, modifying, deleting, and/or updating user applications in response to queries, requests, modifications, and/or other user commands;
   one or more AI modules 320 for using AI/ML models (e.g., supervised, unsupervised, deep, and/or reinforcement learning models) to generate user interface components, client-requested application service functions, underlying mathematical structure to model data and make predictions, and/or other application components;
   one or more specification language modules 322 for using well-defined grammar and rules to specify application requirements, ensure precision, describe functional requirements, describe non-functional requirements, use data structures, interfaces, and protocols, provide automated validation against implementation to ensure conformance to specifications, and/or other functions;
   one or more functional programming language modules 324 for rigorously defining grammar and rules to write specifications, detail functional and non-functional requirements of the application, define interfaces, protocols, and/or data structures, support methods for verifying completeness, consistency, correctness, and/or updates of the specifications, and/or other techniques to ensure the application generation module 314 meets specifications for the client-requested application;
one or more data modules 330 for handling storage, access, and/or edits to data (e.g., user data, application data, IT department data, etc.). In some embodiments, the one or more data modules 330 include:
   configuration data 332 (e.g., regarding pre-built components, functionally verified application elements, application verification protocols, etc.);
   one or more coding libraries 334 for storing coding data such as syntax, logic, commands, components, instructions, and other metadata;
   interface data 336 (e.g., regarding user interface elements, components, functionalities, input/output network interface elements, etc.);
   prompt generation data 338 (e.g., regarding LLMs, NLP based queries and responses, etc.);
   AI data 340 (e.g., regarding AI modules, configurations, settings, parameters, models, architectures, etc.);
   specification language data 342 (e.g., regarding client requirements, IT department policies, security protocols, privacy policies, etc.); and
   functional programming data 344 (e.g., regarding programming language flows, decision trees, logic flows, etc.).

In some embodiments, the application development design hub 120 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Although FIG. 3 illustrates the application development design hub 120 in accordance with some embodiments, FIG. 3 is intended more as a functional description of the various features that may be present in an application development design hub than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the application development design hub 120, and how features are allocated among them, will vary from one implementation to another and, optionally, depends in part on an amount of data traffic that the server system handles during peak usage periods as well as during average usage periods.

Each of the above identified modules stored in the memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, the memory 212 and 306 optionally store a subset or superset of the respective modules and data structures Utility Application identified above. Furthermore, the memory 212 and 306 optionally store additional modules and data structures not described above.

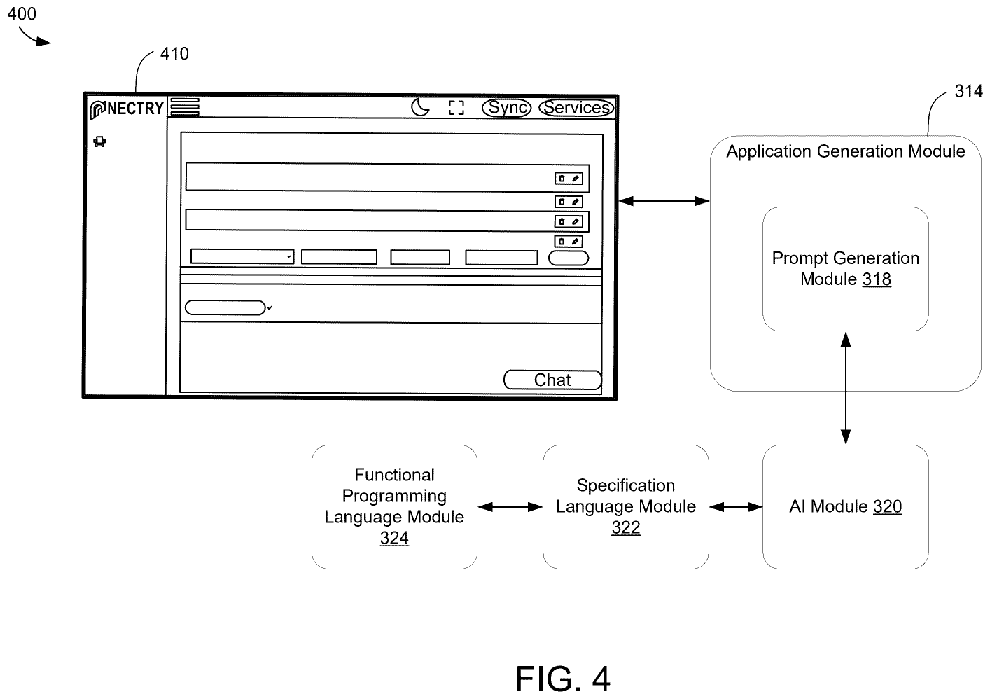

FIG. 4 shows an example of a generated user interface by an application generation module in accordance with some embodiments. In some embodiments, the application generation module (e.g., the application generation module 314 of FIG. 3) generates a conversational user interface 410 configured to interact with a user through natural-language dialogue. In the example of FIG. 4, the application generation module uses a prompt generation module (e.g., the prompt generation module 318 of FIG. 3), an AI module (e.g., the AI module 320 of FIG. 3), a specification language module (e.g., the specification language module 322 of FIG. 3), and/or a functional programming language module (e.g., the functional programming language module 324 of FIG. 3) to generate the conversational user interface 410. In some embodiments, the application generation module 314 includes one or more of: the AI module 320, the specification language module 322, and the functional programming language module 324.

In some embodiments, the application generation module 314 is a decision-tree module configured to generate a sequence of prompts based on the natural-language dialogue and dynamically select subsequent prompts based on user responses. In some embodiments, the application generation module 314 includes one or more decision-trees. In some embodiments, the application generation module 314 uses the prompt generation module 318 to generate specially engineered prompts for a language model based on the one or more decision trees and available application components. For example, the prompt generation module 318 may convert natural language inputs from a user into structured prompts for the language model. In some embodiments, the prompt generation module 318 is in communication with the AI module, the specification language module, and/or the functional programming language module 324. In some embodiments, the specification language module 322 is configured to apply formal program-verification techniques to ensure correctness and absence of security vulnerabilities in the generated application. In some embodiments, the specification language module 322 is a verification module. In some embodiments, the specification language module 322 acts as an interface between the AI module 320 and the functional programming language module 324 to ensure that code generated by the AI module is functionally correct, complies with various rules/regulations, and does not introduce security vulnerabilities. For example, the AI module 320 may only be aware of the specification language module 322, and not the functional programming language module 324.

In some embodiments, the conversational user interface 410 has one or more user interface elements and/or components configured based on user requests and/or responses, the one or more decision trees, and one or more specially engineered prompts associated with the specific language model. In some embodiments, the application generation module 314 generates the user interface in the functional programming language using the specification language, e.g., by identifying a simplified subset of the functional programming language, sufficient for configuring and plugging together components, rather than generating new components. This enables the generation of a user interface that is guided by expressive type information and prevents users from developing ill-formed code that is error prone and/or vulnerable to exploitation. The expressive type system can enable code safety, correctness, and reduced runtime errors. Static analysis can facilitate optimization, enforce coding standards, and detect vulnerabilities without requiring compilation.

In some embodiments, application generation module 314 builds different static program analyses that run on the simplified subset of that language. For example, the application generation module 314 uses expressive type languages that constrain the program space, simplifying the process of searching for an acceptable program. The application generation module 314 can leverage the expressive type of language to build static programs and answer questions about security policies. Such a user-specific request would be much more difficult to build with a general-purpose AI model or programming language. In some embodiments, the application generation module 314 produces scalable binaries enabling the development of a whole-program optimization compiler. In some embodiments, the scalable binaries are developed based on high-level source code. Some embodiments include an intermediary component (e.g., the application generation module 314, FIGS. 3 and 4) between the user and an artificial intelligence component (e.g., the AI module 320, a generative AI, one or more large language models (LLMs), or other types of AI and/or machine learning). In this way, users can describe what they want to accomplish to the intermediary component in plain language, without needing to use technical or programming terms. The intermediary component may then communicate with the AI component (e.g., the AI module 230, FIGS. 3 and 4), e.g., using engineered prompts and a dynamic decision tree to extract technical specifications from the user's request. Additionally, by constraining the AI component's responses through the decision tree, the intermediary component can prevent incorrect responses and ensure that the developed application satisfies type correctness and other rules. In some embodiments, the decision tree is dynamically generated based on the user request, the current state of the conversation, the functional capabilities of the available components, their relevance to the user request, and/or the type of structure of a respective component library. For example, the AI models (e.g., AI model(s) 150, AI module 320, etc.) may not be required to understand the programming framework (e.g., the underlying functional programming language). Instead, the specification language module can provide enough information for the application generation module 314, production application generator(s) 170 and/or code generator(s) 160 to generate the decision tree. In some embodiments, the structures in a software library are checked automatically (e.g., in response to particular events) for continued fidelity to the real code base.

In some embodiments, the dynamic decision tree is generated by guaranteeing certain properties such as adherence to company-specific security, privacy, authentication, and/or access policies. This ensures that the AI component's responses based on dynamic decision trees are in compliance with the underlying security, privacy, authentication, and/or access policies. In some embodiments, user inputs associated with one or more user requests that are not in compliance with the underlying policies are disregarded, revised, or reverted to the user (e.g., automatically). In some embodiments, the selection of and development of interface components (e.g., by the AI component or an intermediary component) are checked against the underlying policies and non-compliant user interface components are disregarded or revised (and optionally the requesting component is notified of the error). In some embodiments, each of the underlying policies are revisable (e.g., may be updated by a policy expert or compliance officer). For example, the security and privacy policies are customizable to be in compliance with each other, and/or editable to incorporate policy updates and/or information technology updates.

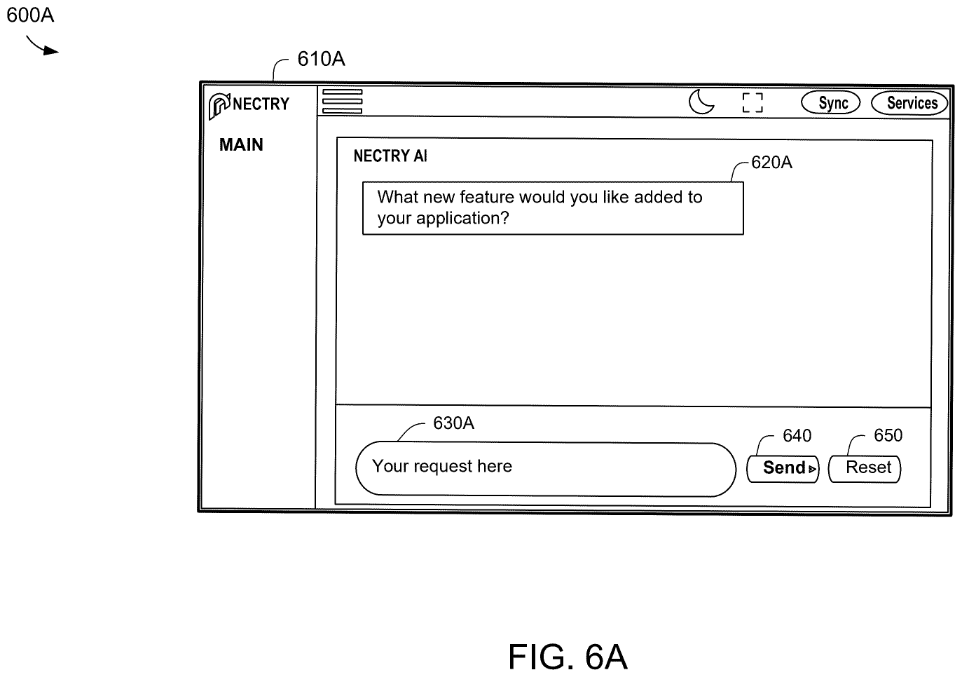

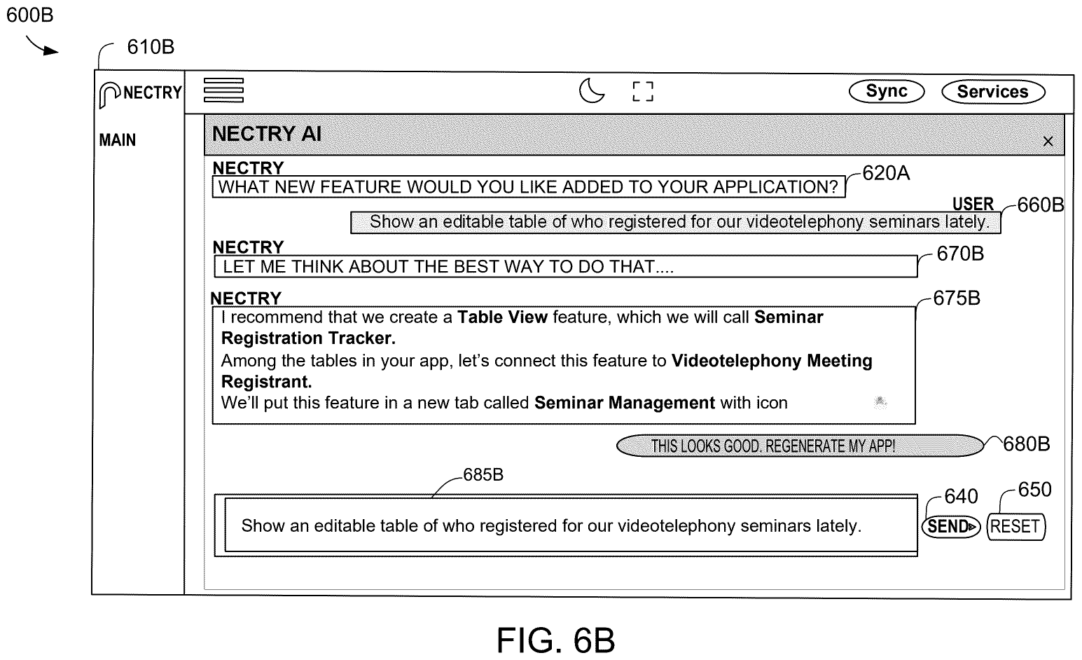

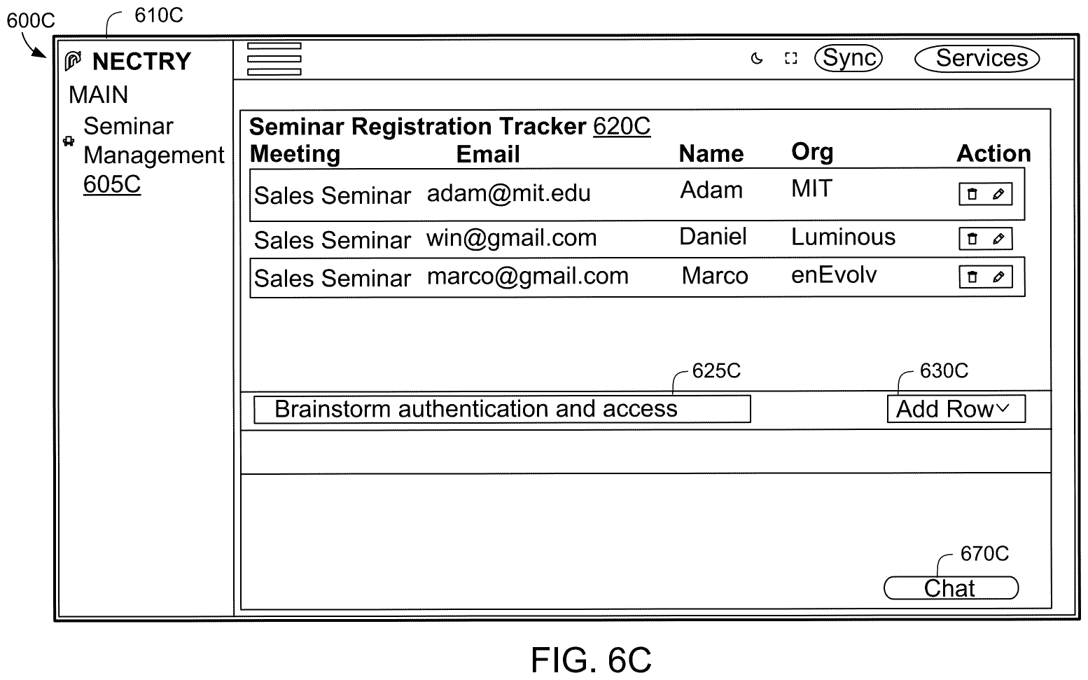

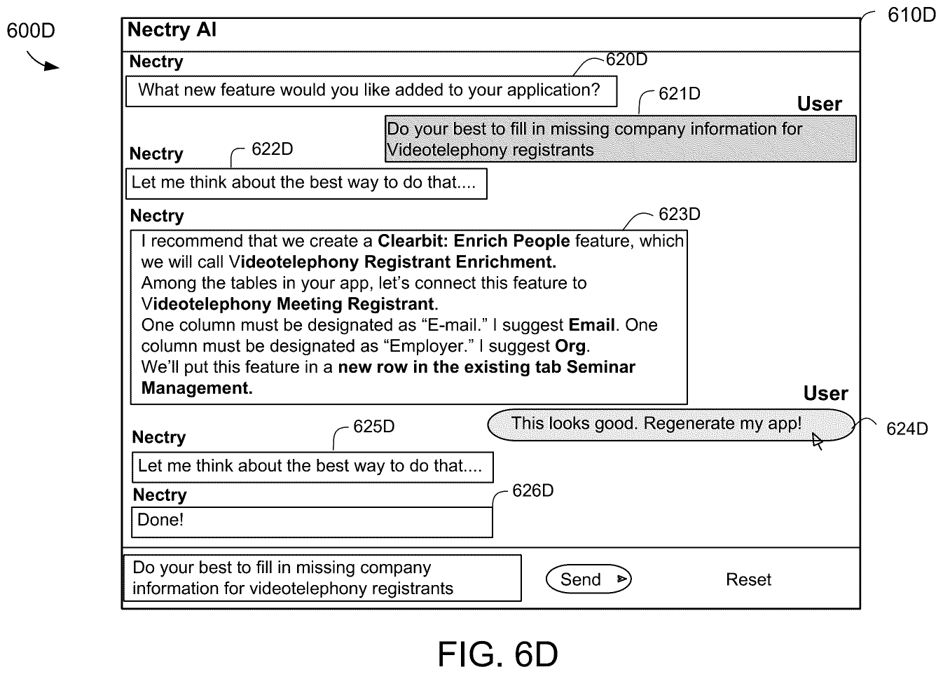

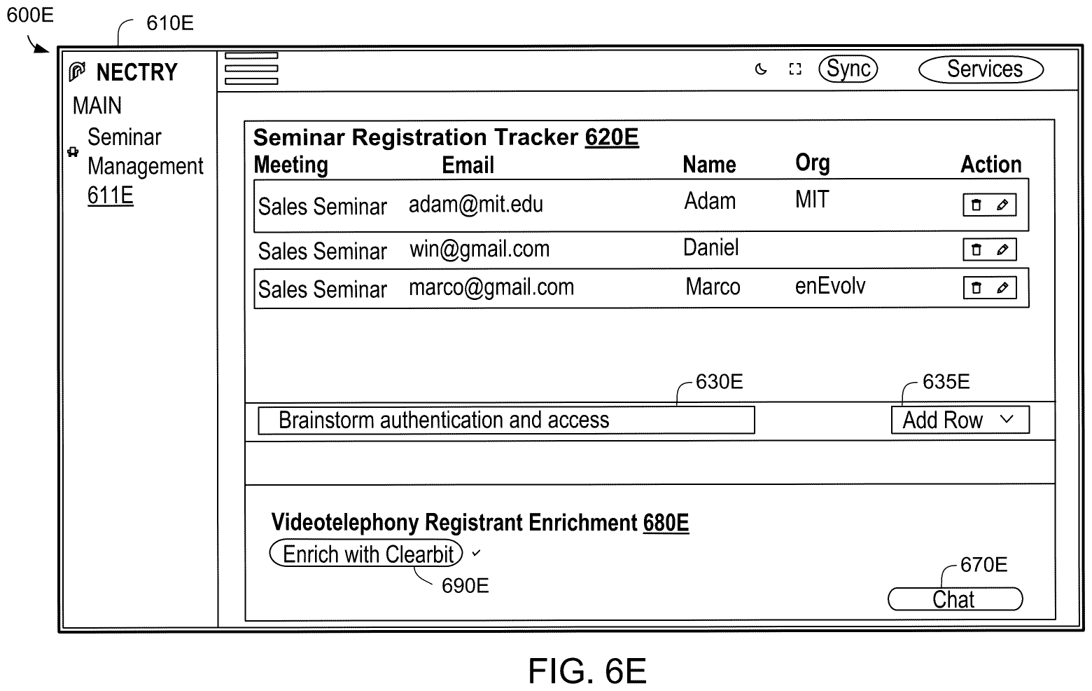

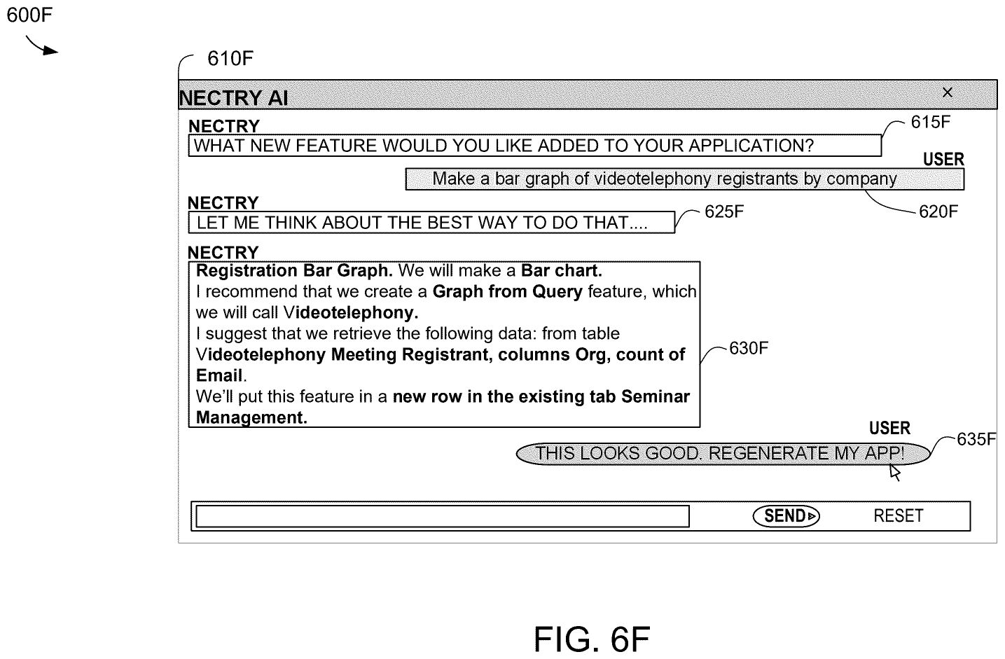

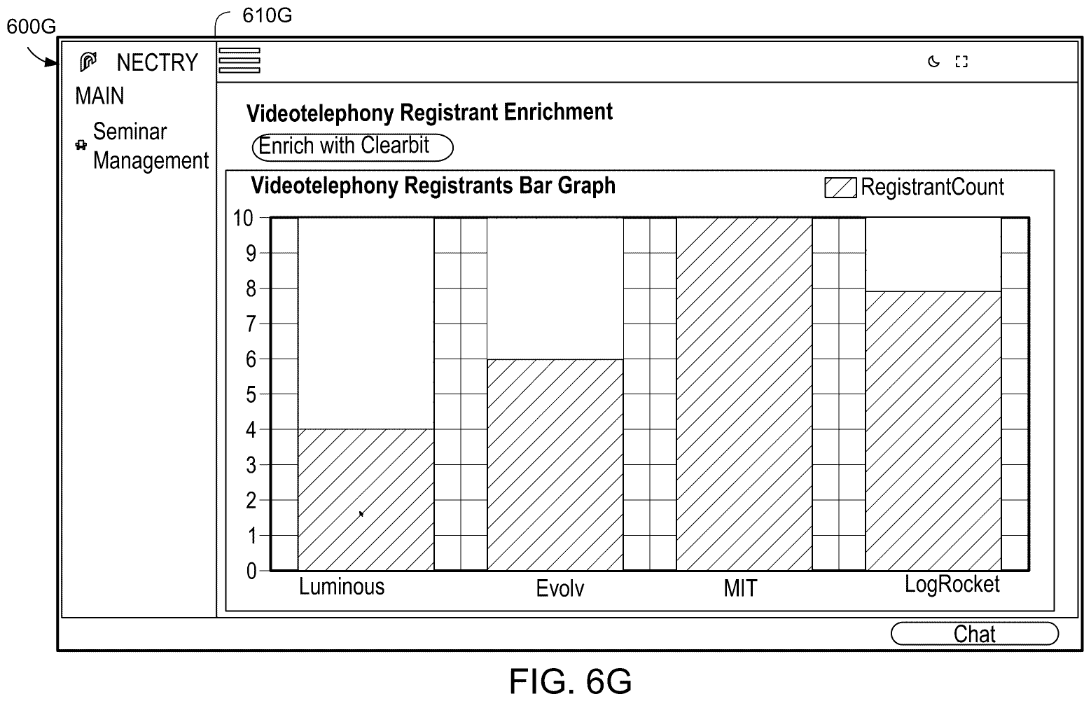

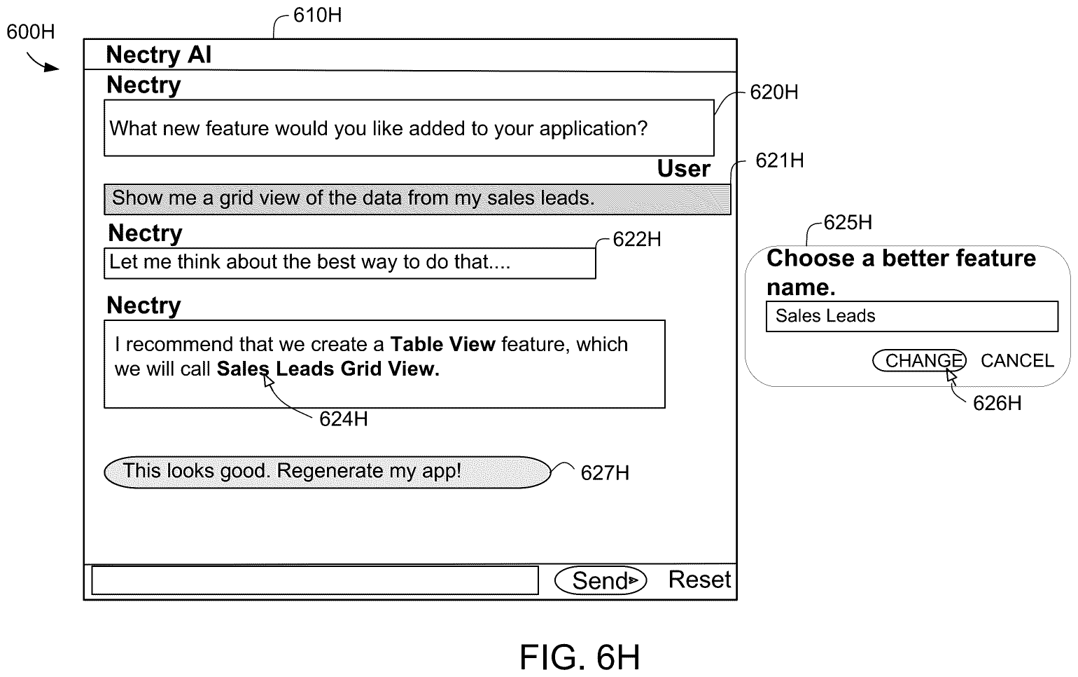

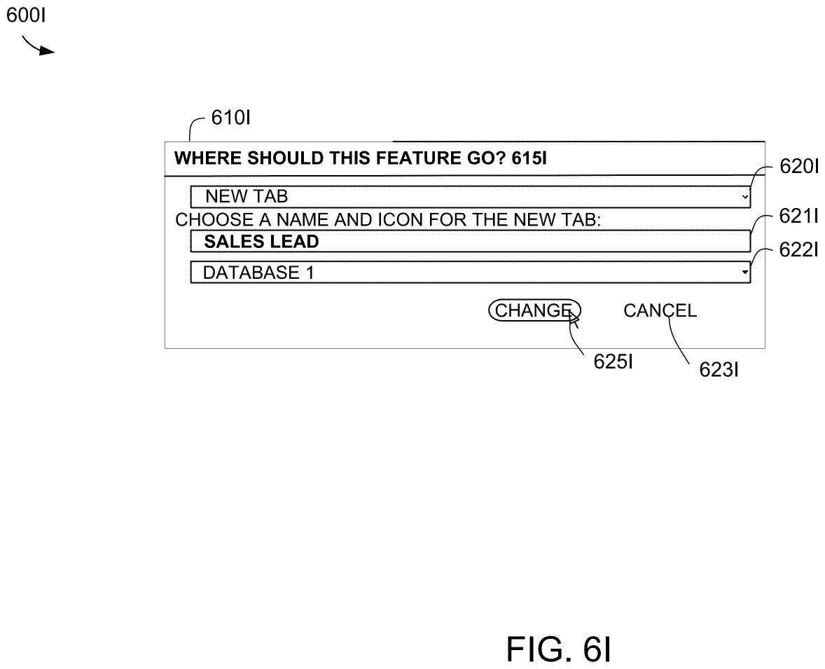

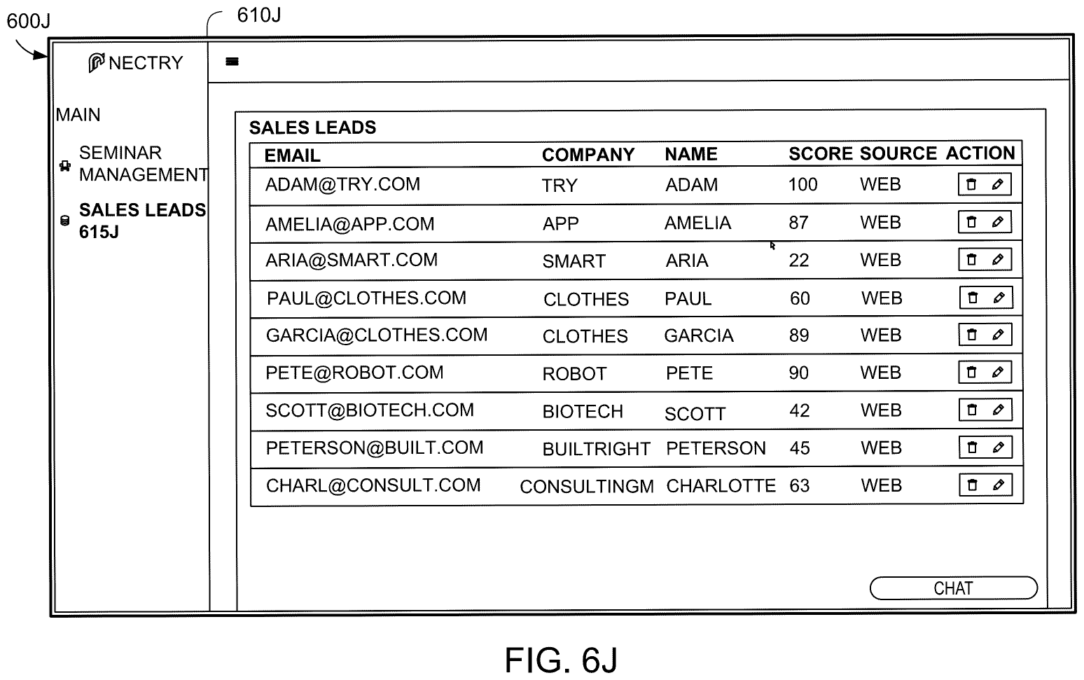

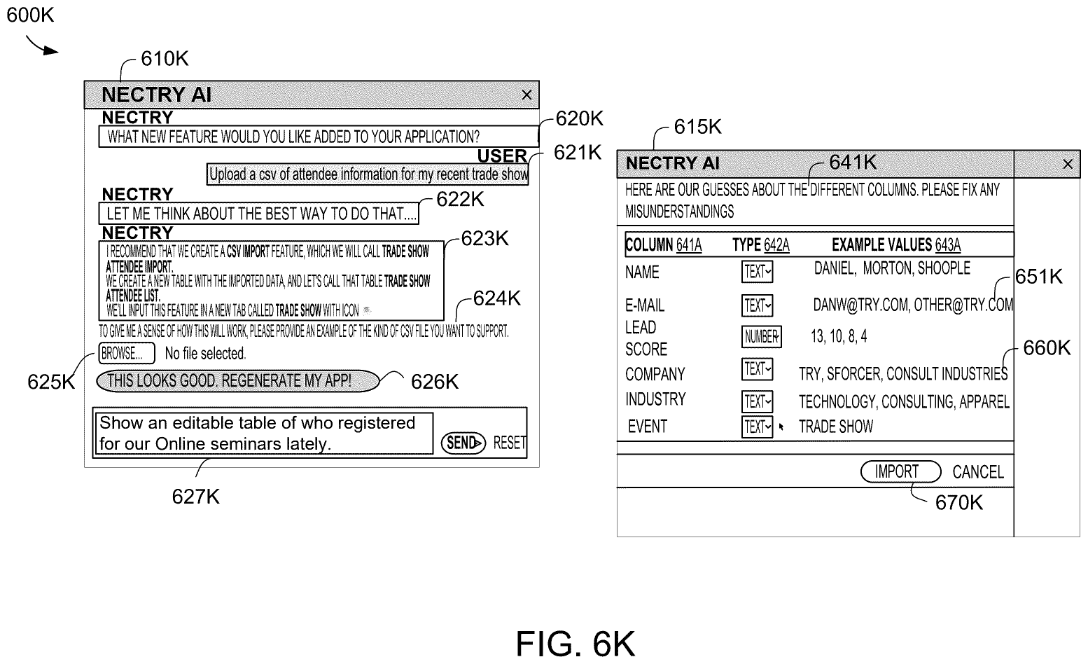

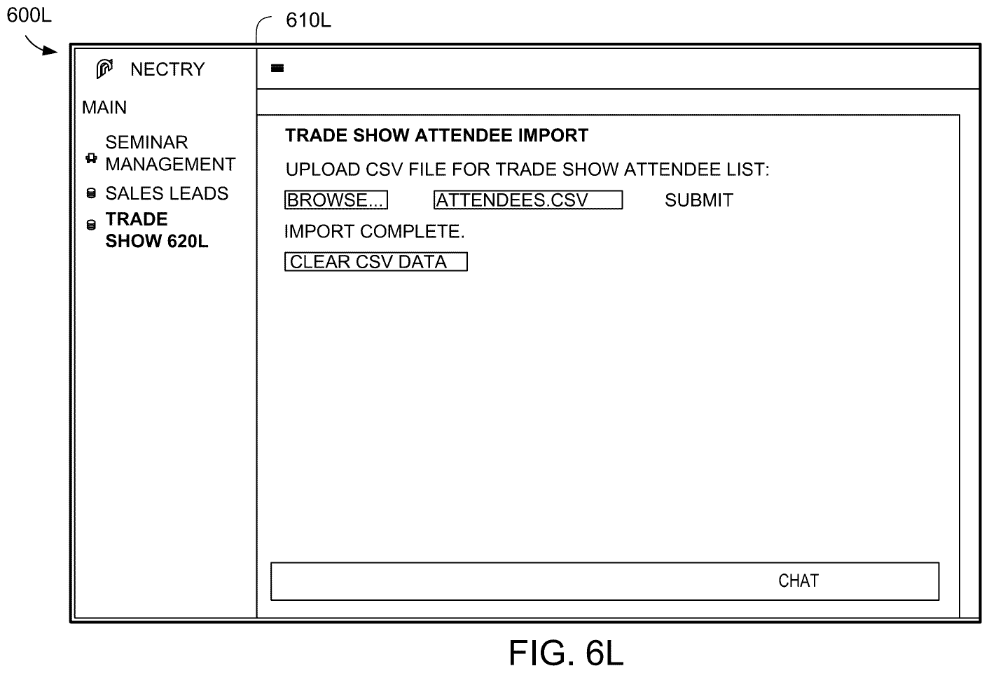

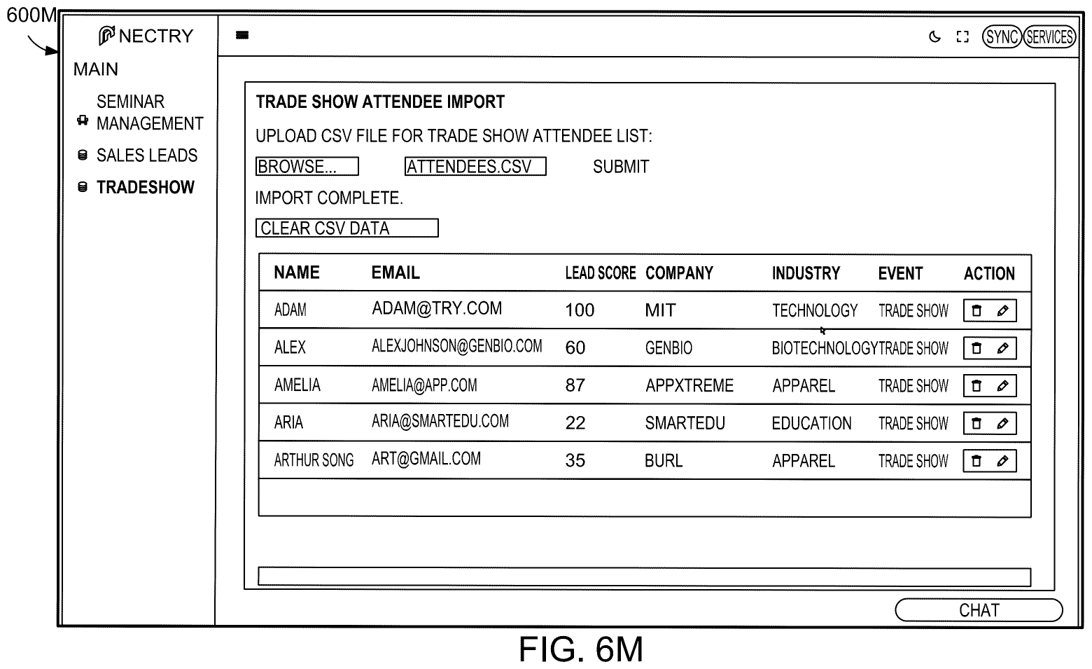

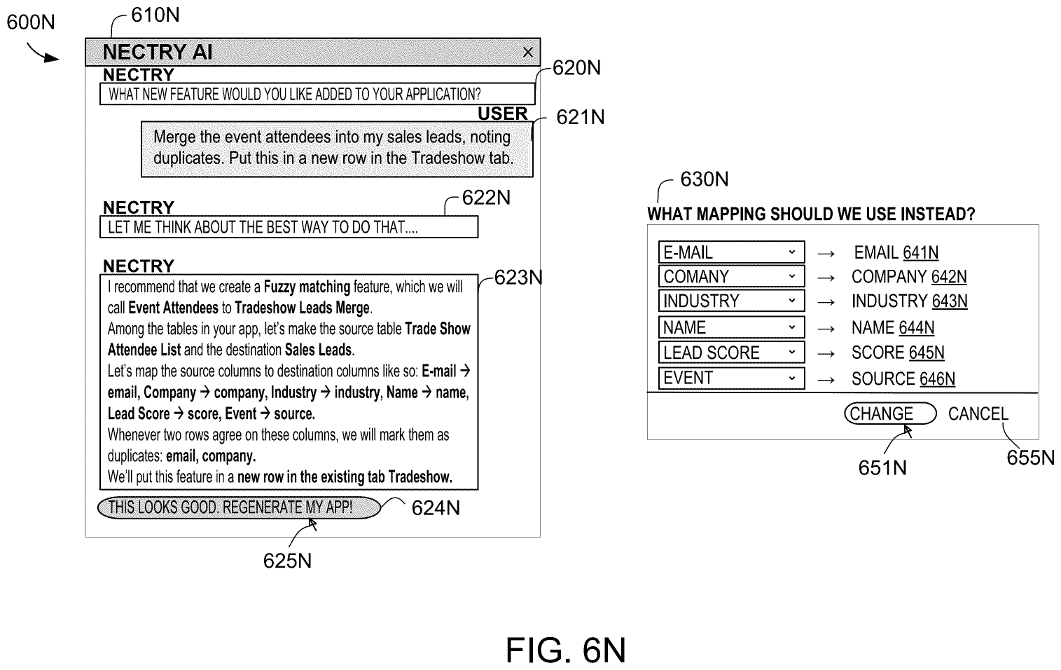

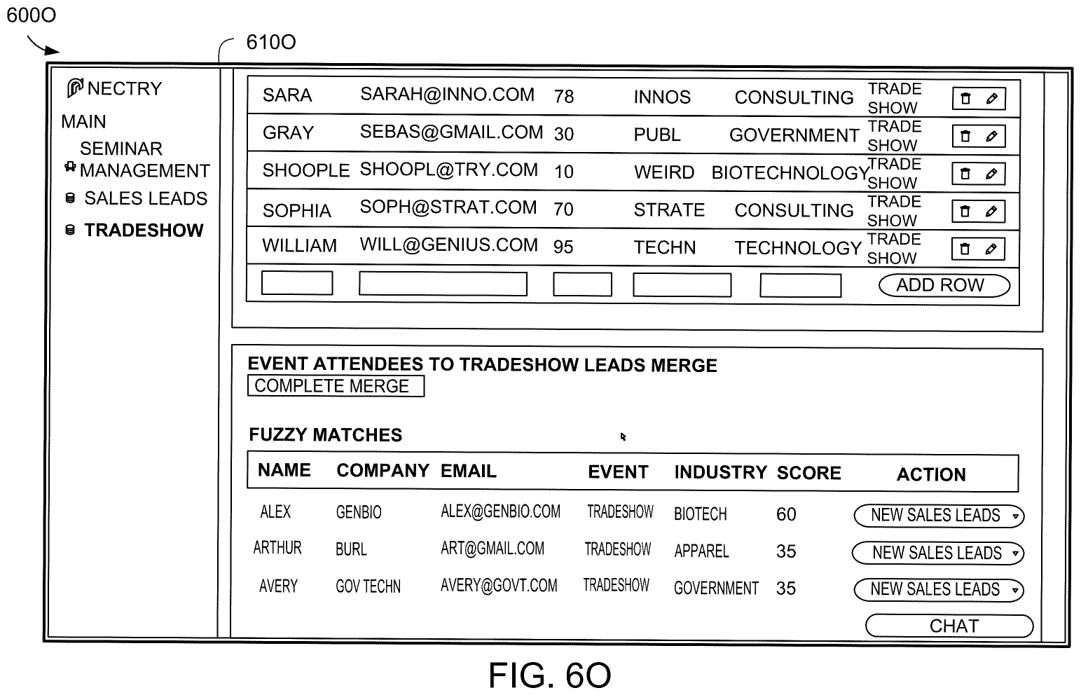

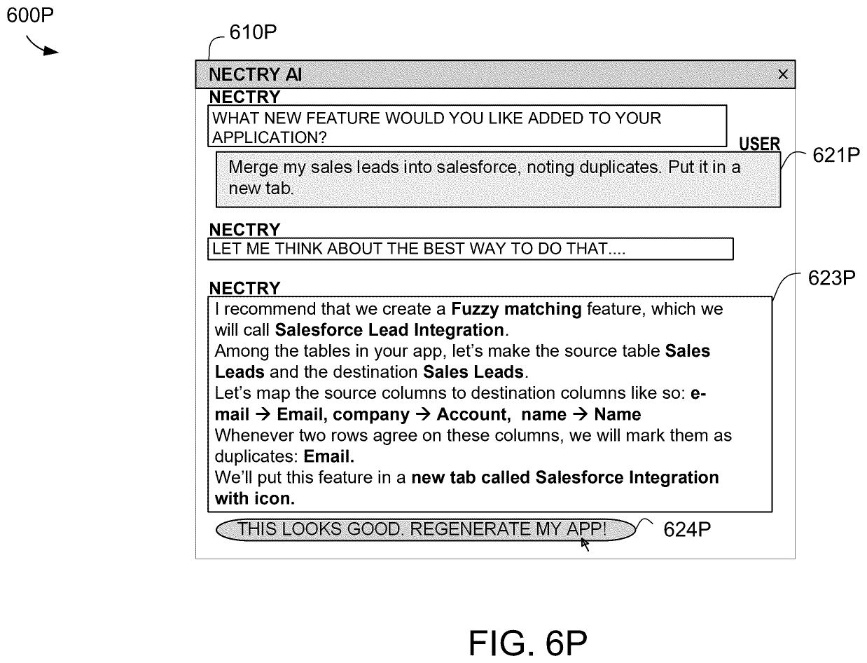

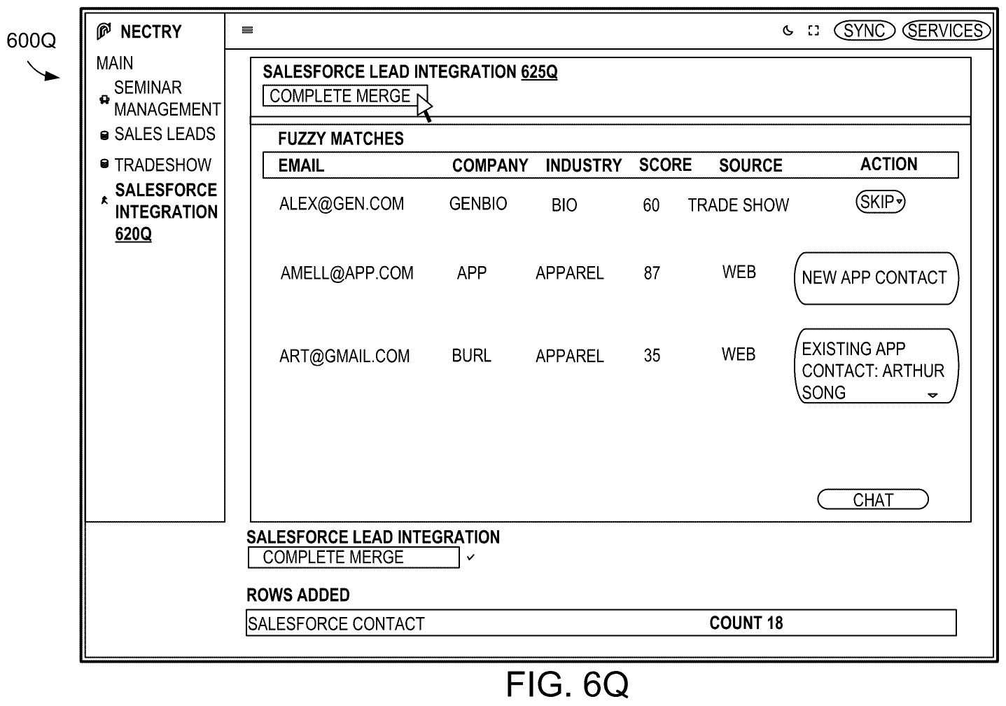

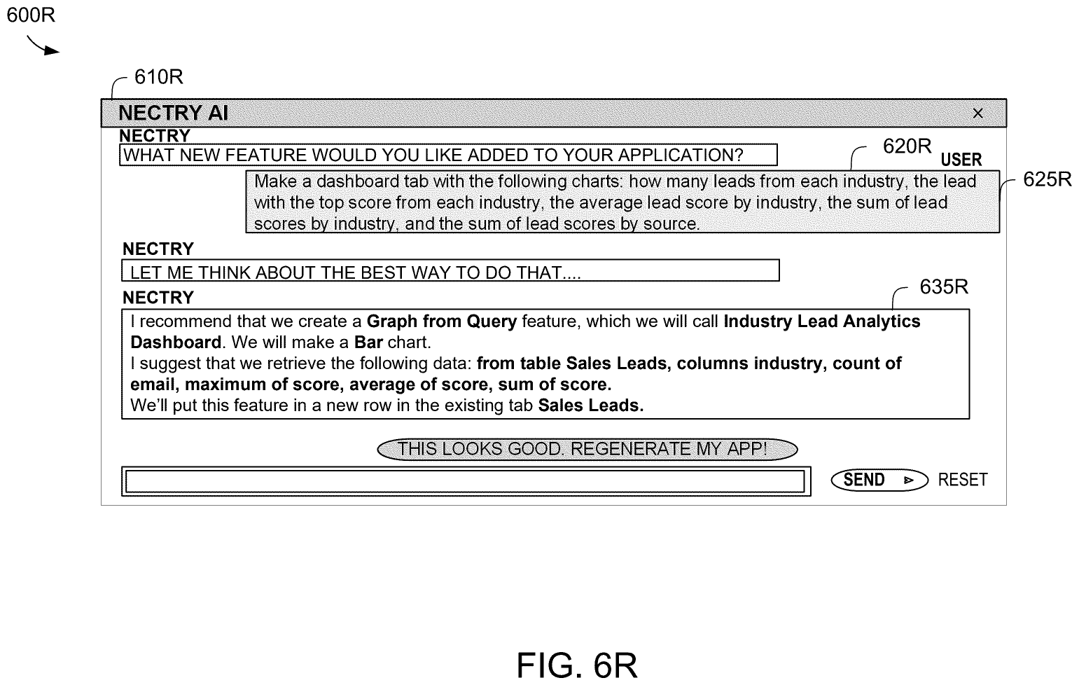

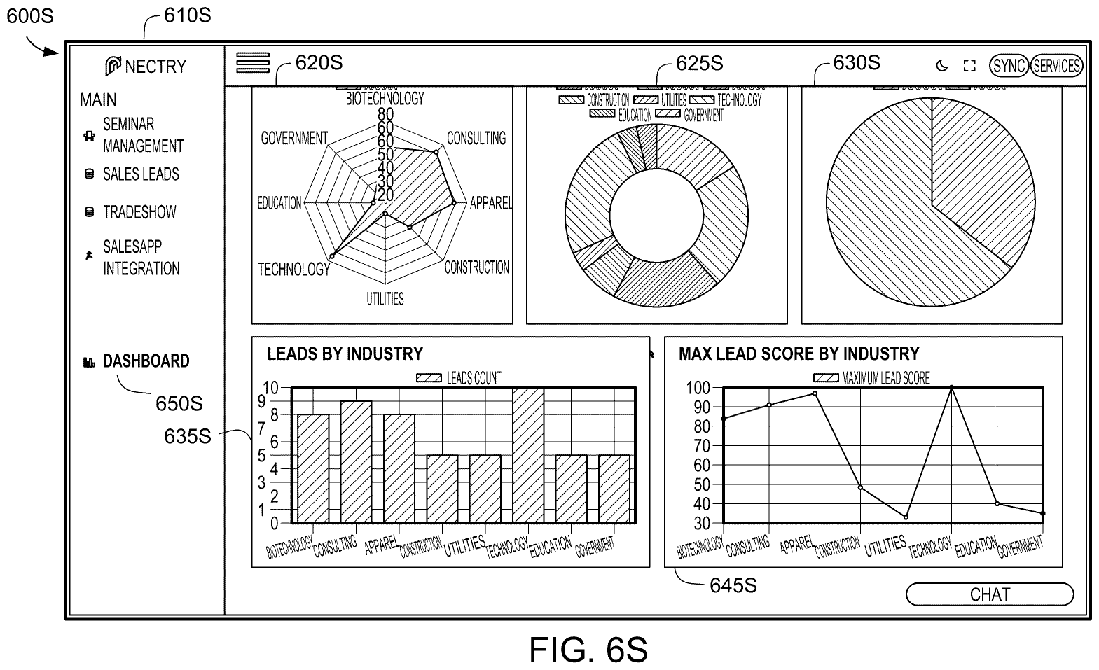

In the process of responding to a user request, the intermediary component may compose a plurality of specially engineered prompts to the AI component, each of which provide some of the information for the creation of the application. For example, in response to a user request, the system may direct the AI component, via a specially engineered prompt which may indicate selection of available application components and their descriptions, to select which component would be the best match to the user's request. Additionally, special prompts may be used to direct and guide the AI component to generate (e.g., select) names for features, icons or other graphic renderings for features and tabs, and how to layout the various features to build a useful and compelling interface (e.g., as illustrated in FIGS. 6A-6S).

In some embodiments, if the AI component needs more information from the user to complete the specifications being produced (e.g., a clarification of the user's request), it signals this to the intermediary component, which asks the user one or more follow-up questions (e.g., in a conversational style), such as asking which APIs and/or data sources should be used with the user's request. As the user provides answers, the intermediary component is configured to dynamically select the next branch in the conversation. This allows for a reactive, multi-round interaction where the user can refine or update their needs. In this way, a business user is made aware of possibilities and capabilities of the system via the conversational interface and the user does not need to explore a large catalog of technical components and decide how to compose and configure them.

For example, the intermediary component is configured to present code as descriptive paragraphs of natural language allowing users with no coding knowledge to understand and edit applications and/or user interface components based on the presented code and/or user interface. Moreover, the generated code is inherently trustworthy due to the use of the specification language (e.g., the specification language module 322) to ensure compliance and proper coding components.

In some embodiments, at least a subset of the specification language components (e.g., pre-generated coding routines, modules, and/or algorithms) are configured to perform higher-level business functions, encapsulating underlying business logic and database or API access (e.g., rather than being low-level user-interface components such as dropdown menus, check boxes, and the like). In some embodiments, the specification language components (e.g., technical components) are prebuilt, tested, and configured with well-typed technical specifications.

As an example, when the intermediary component has acquired from the AI component the technical specifications it needs to properly generate/configure the generated application (e.g., user interface), the intermediary component may describe these specifications to the user in plain, non-technical language. Additionally, elements of the description may be editable, allowing the user to modify the technical specifications, if desired (e.g., by presenting valid, selectable alternatives). Additionally, the user can make a follow-up request, e.g., asking for modifications, additions, or deletions, which triggers another round of interaction with the AI component. In this way, an application is customized for the user through a natural-language dialogue rather than needing to directly edit coding elements.

In some embodiments, a prompt is generated to include the schema of a table which is being used by a selected component. In some embodiments, the prompt provides guiding and/or guard-rail instructions to the AI component to generate a structured statement (e.g., an SQL statement, such as a SELECT statement) that the application will use.

The language that users employ in describing the desired functionality of the new application may be different from the language used to describe available application components, data, and/or API sources available for integration in the new application. In some embodiments, the intermediary component is configured (e.g., via a prompt-engineering process) to precisely map user terminology to system capabilities and handle a lack of precision in user input.

In some embodiments, one or more policy documents (and/or other sets of instructions) are provided (e.g., by the intermediary component) as part of prompts to the AI component to ensure that a generated application will conform to those policies. Example policy documents include external ones from regulatory bodies, such as the GDPR, or the Payment Card Industry Data Security Standard (PCI DSS), or HIPAA; and internal ones of an enterprise, such as an enterprise data security policy governing data usage, data sharing, data encryption, and/or data masking. For example, an enterprise policy could restrict what types of sensitive data, such as Personally Identifiable Information (PII), are allowed or prohibited to flow to certain external APIs or systems or databases. The nature of the underlying specification language (e.g., simplified programming language subsets/components) enables the determination of information flow so that policies can be enforced in the generated application. Many security issues may result from the misconfiguration of systems (e.g., human error), therefore it is advantageous to have a system that automatically ensures information security and data flows.

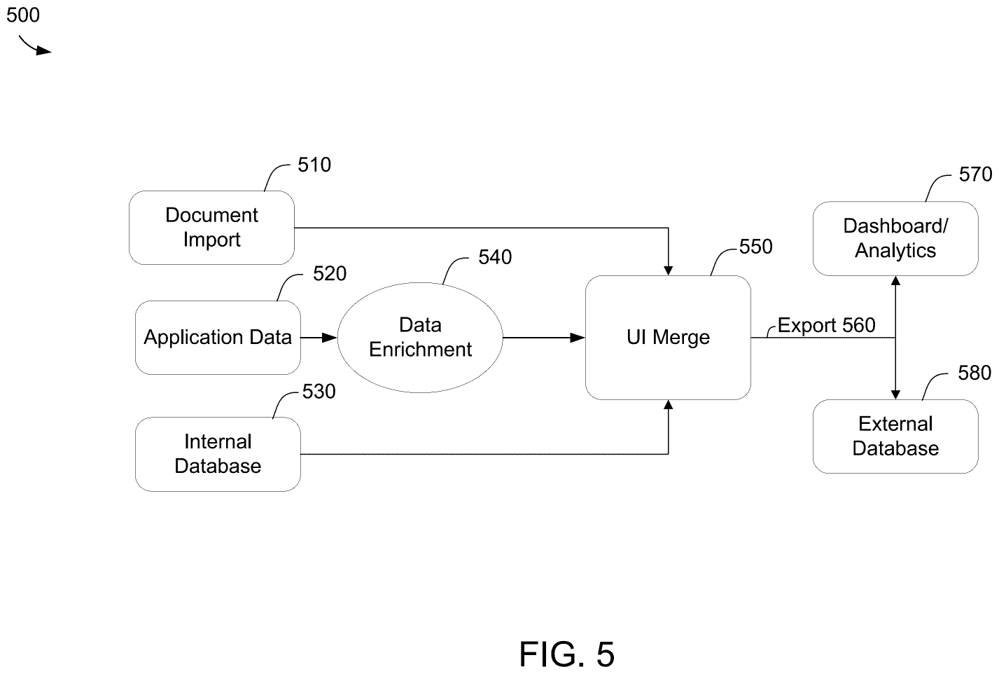

FIG. 5 shows an example flow for generating an application, such as a conversational user interface. The generation of the application may be based on receiving one or Utility Application more user inputs that indicate (e.g., upload) at least one document, point to and/or upload a database, and/or upload application data. The data associated with the one or more user inputs is analyzed to generate one or more application components (e.g., visually presented data analytics, images, interactive agents, etc.). In some embodiments, the application components (e.g., conversational user interface components) are editable via subsequent user inputs. In some embodiments, the application components are generated based on one or more natural language inputs responsive to one or more contextual prompts (e.g., generated by the prompt generation module 318), the AI module 320, the specification language module 322, and the functional programming language module 324.

In some embodiments, the application generation platform uses a document import 510 feature to upload at least one document, an application data import 520 feature to upload, authenticate, and/or link the application data 520, and/or a database import 530 feature to access an internal database (e.g., application database 125, AI database 130, component database 135, ML database 140, etc.) and/or an external database associated with external AI models and/or other data sources.

In some embodiments, the application generation platform generates one or more application (e.g., user interface) components based on extracting and/or analyzing data from the document import 510, application data 520, internal database 530, and/or other data sources. The one or more application components can be personalized, predesigned, and/or structured components (e.g., associated with a logic tree, a decision tree, etc.) configured to provide the user with data analytics tools, graphical visual representations, AI content, and/or seamless connectivity with databases and AI tools. In some embodiments, the one or more application components are based on stored user preferences, business rules, security policies, compliance policies, authentication procedures, and/or other functional tools.

In some embodiments, the application generation platform has a data enrichment 540 feature that provides a user an option to enrich the uploaded application data via the application data import 520 feature. The data enrichment allows a user to instruct the application generation platform to add additional data sources (e.g., user specified, publicly available, AI generated, LLM generated, trusted third-party sources, etc.) for generating one or more additional application components. The application generation platform can be configured to communicate, request, receive, and/or extract data from the additional data sources based on sending metadata to other server systems associated with the additional data sources. In some embodiments, the additional sources of data include a text-based source file associated with a user program.

The one or more application components and/or the additional application components can be pre-enabled with drag and drop functionalities. In some embodiments, the user interface components are pre-tested components with verified functionalities and/or data interfaces. In some embodiments, at least some of the user interface components are implemented using a Turing-complete language. Turing complete languages are computationally universal (e.g., able to compute any type of calculation). For example, programming languages such as Python, C++, Java, and Solidity are Turing complete. In some embodiments, at least some of the application components are selected by a user from a set of application components implemented using a Turing-complete language. In some embodiments, at least some of the application components are editable components with accessible source code that a user can edit. In some embodiments, at least some of the application components are not implemented using a Turing-complete language. In some embodiments, the functional programming language is Turing-complete, whereas the specification language is not Turing complete.

In some embodiments, the application generation platform provides user options for a user interface merge 550 that merges user interface components based on imported document data, the application data 520, the internal database 530, the data enrichment 540, and/or other data sources. In some embodiments, the application generation platform exports 560 the merged user interface components to dashboard analytics 570 and/or an external database 580. In some embodiments, the merged user interface components are exported to a client system (e.g., client device 110).

The merged user interface components may be editable by allowing a user to edit their parameters and/or configurations. In some embodiments, the merged user interface components are lockable from editing, e.g., based on business rules, access rules, authentication rules, client information technology department rules, user permissions, user job titles, user job functions, confidentiality requirements, and/or other permission types for users granted access to the generated conversational user interface with the one or more user interface components.

FIGS. 6A-6S illustrate an example application generation process (e.g., via an application development design hub 120) in accordance with some embodiments. FIG. 6A shows an illustration of an example conversational user interface. In some embodiments, the application generation module 314 (and/or the application development design hub 120) generates a conversational user interface 610A with a first prompt 620A (“What new feature would you like added to your application?”) and a chat box element 630A associated with one or more interactive user interface elements (e.g., “Send” 640, “Reset” 650, etc.).

FIG. 6B shows an illustration of another example conversational user interface. In some embodiments, the application generation module 314 (or the application development design hub 120) generates the conversational user interface 610B. In some embodiments, the conversational user interface 610B is an instance of the conversational user interface 610A after some subsequent user interaction. In some embodiments, the conversational user interface 610B has one or more user request chat elements for receiving corresponding user requests. For example, the conversational user interface 610B has a first user request chat element configured to accept a user request 660B labeled “Show an editable table of who registered for our videotelephony seminars lately” and a user request chat element 680B configured to accept a second user request, labeled “This looks good. Regenerate my app!”. In some embodiments, the conversational user interface 610B provides responses to the one or more user requests via one or more prompt elements that cause display of generated prompts (e.g., “Let me think about the best way to do that” 670B, “I recommend that we create a Table View feature, which we will call Seminar Registration Tracker. Among the tables in your app, let's connect this feature to Videotelephony Meeting Registrant. We'll put this feature in a new tab called Seminar Management with icon” 675B, etc.). In some embodiments, the conversational user interface 610B has a user request chat element 685B that is a conversational chat element associated with send 640 and reset 650 features. The user request chat element 685B is configured to accept a third user request (e.g., “Show an editable table of who registered for our videotelephony seminars lately”).

FIG. 6C shows an illustration of another example conversational user interface. In some embodiments, the application generation module 314 (or the application development design hub 120) generates a conversational user interface 610C. In some embodiments, the conversational user interface 610C is generated responsive to the user request 660B and the user request 680B described above with respect to FIG. 6B. The conversational user interface 610C generates the requested “Seminar Registration Tracker” 620C under a user interface tab “Seminar Management” 605C. The “Seminar Registration Tracker” 620C can include information about seminar attendees (e.g., e-mail address, name, organization, type of seminar, etc.). In some embodiments, the “Seminar Registration Tracker” 620C has editable user elements for receiving one or more user actions (e.g., edit, delete, etc.). The conversational user interface 610C can enable customizable user interface elements such as “Brainstorm authentication and access” 625C and “Add row” 630C. In some embodiments, the conversational user interface 610C has a user element configured to allow a user to activate a conversational feature of the user interface (e.g., “Chat” 670C).

FIG. 6D shows an illustration of an example conversational user interface. In some embodiments, the application generation module 314 (or the application development design hub 120) generates a conversational user interface 610D. In some embodiments, the conversational user interface 610D builds upon the features presented by the conversational user interface 610C. For example, the conversational user interface 610D generates a prompt (e.g., “What new feature would you like added to your application?” 620D) and in response, receives a user request (e.g., “Do your best to fill in missing company information for Videotelephony registrants” 621D). The conversational user interface 610D then generates one or more responses (e.g., “Let me think about the best way to do that” 622D, “I recommend that we create a Clearbit: Enrich People feature, which we will call Videotelephony Registrant Enrichment. Among the tables in your app, let's connect this feature to Videotelephony Meeting Registrant. One column must be designated as “E-mail.” I suggest Email. One column must be designated as “Employer.” I suggest Org. We'll put this feature in a new row in the existing tab Seminar Management” 623D) based on the user request, a dynamic decision tree, user data, AI model(s), and/or other user interface components (e.g., expressive static type components). The user provides the go ahead to regenerate the application based on approving the one or more responses (e.g., “This looks good. Regenerate my app!” 624D). In some embodiments, the conversational user interface 610D begins to regenerate the user requested application and generates one or more notifications (e.g., “Let me think about the best way to do that” 625D, “Done!” 626D, etc.) during the application regeneration process to keep the user informed of the application regeneration progress.

FIG. 6E shows an illustration of an example conversational user interface. In some embodiments, the application generation module 314 (or the application development design hub 120) generates a conversational user interface 610E that builds upon the requested user interface feature “Do your best to fill in missing company information for Videotelephony registrants” 621D of FIG. 6D described above. The conversational user interface 610E presents at least one user interface element (e.g., “Brainstorm authentication and access” 630E, “Add Row” 635E, “Videotelephony Registrant Enrichment” 680E, “Enrich with Clearbit” 690E, etc.) for enabling a user to select the user interface element that is associated with the requested user interface feature. For example, the conversational user interface 610E presents the user interface element 690E “Enrich with Clearbit” for enriching the videotelephony meeting registrant information presented by the conversational user interface 610D. In some embodiments, the conversational user interface 610E is configured to provide a chat-based user interface element 670E to provide a user with the option to activate a chat mode. In some embodiments, the chat mode is configured to enable a user to provide the application generation module 314 (or the application development design hub 120) with additional user requests in natural language format to customize, edit, create, generate, and/or build upon the conversational user interface 610E.

FIG. 6F shows an illustration of an example conversational user interface. In some embodiments, the application generation module 314 (or the application development design hub 120) generates a conversational user interface 610F that presents a first prompt (e.g., “What new feature would you like added to your application” 615F). In response to the first prompt, in some embodiments, a user can provide one or more requests (e.g., “Make a bar graph of videotelephony registrants by company” 620F). The conversational user interface then provides one or more suggestions (e.g., “Let me think about the best way to do that” 625F, “Registration Bar Graph. We will make a Bar chart. I recommend that we create a Graph from Query feature, which we will call Videotelephony. I suggest that we retrieve the following data: from table Videotelephony Meeting Registrant, columns Org, count of E-mail. We'll put this feature in a new row in the existing tab Seminar Management” 630F, etc.) for regenerating the conversational user interface application. In some embodiments, the user can approve the one or more suggestions by instructing the application generation module 314 (or the application Utility Application development design hub 120) to regenerate the requested user application (e.g., “This looks good. Regenerate my app!” 635F).

FIG. 6G shows an illustration of an example conversational user interface. In some embodiments, the application generation module 314 (or the application development design hub 120) generates a conversational user interface 610G that builds upon the requested user interface feature “Make a bar graph of videotelephony registrants by company” 620F of FIG. 6F described above. For example, the conversational user interface presents the requested bar graph of registrants of the videotelephony meeting described with respect to FIGS. 6B-6F above.

FIG. 6H shows an illustration of an example conversational user interface. In some embodiments, the application generation module 314 (or the application development design hub 120) generates a conversational user interface 610H. In some embodiments, the conversational user interface 610H generates a first prompt (e.g., “What new feature would you like added to your application” 620H). If the conversational user interface receives a user request (e.g., “Show me a grid view of the data from my sales leads” 621H), the conversational user interface can analyze the user request, generate a status update indicative of a start of the analysis process (e.g., “Let me think about the best way to do that” 622H), and generate one or more recommendations at the end of the analysis process (e.g., “I recommend that we create a Table View feature, which we will call Sales Leads Grid View” 624H). If the user approves of at least one recommendation of the one or more recommendations, the user can send the approval via a natural language input accepting the at least one recommendation of the one or more recommendations (e.g., “This looks good. Regenerate my app!” 627H). If the user does not approve of at least one recommendation of the one or more recommendations, the user can send disapproval information via a natural language input providing explanation information for the user request that includes details about the requested user interface feature (e.g., additional documents, database information, preferred presentation format, functional components, etc.). In some embodiments, the one or more recommendations generated and displayed by the conversational user interface at the end of the analysis process have one or more editable user interface elements (e.g., designation, name, layout, data input source, etc.). For example, the user interface element for “Sales Leads Grid View” of the one or more recommendations 624H is an editable name. If a user does not approve of the recommended user interface element designation, the conversational user interface is configured to allow the user to edit the user interface element designation by generating a pop-up user interface with editable options (e.g., “Choose a better feature name” 625H) that the user can select (e.g., “Change” 626H).

FIG. 6I shows an illustration of an example editable user interface feature of a conversational user interface. In some embodiments, the application generation module 314 (or the application development design hub 120) generates a user interface 610I that enables a user to customize one or more aspects (e.g., location, layout, name, input data source, storage destination, designation, etc.) of an editable user interface feature (e.g., “New Tab” 620I). For example, the user interface 610I prompts a user about a layout aspect of the requested user interface feature (e.g., “Where should this feature go?” 615I), a name and icon for the editable user interface feature (e.g., “Choose a name and icon for the new tab” 621I) and data storage location (e.g., “database 1” 622I). The user interface can provide user selectable options such as “Change” 625I and “Cancel” 623I to instruct the conversational user interface to change or cancel the associated one or more aspects of the editable user interface feature respectively.

FIG. 6J shows an illustration of an example conversational user interface. In some embodiments, the application generation module 314 (or the application development design hub 120) generates a conversational user interface 610J in response to the user request 621H, the pop-up user interface 625H, and the editable user interface feature 620I described above with respect to FIG. 6H. For example, the conversational user interface 610J generates a new tab “Sales Leads” 615J in addition to the “Seminar Management” tab 605C (or 611E) described with respect to FIGS. 6C-6E and causes display of the sales leads related information (e.g., e-mail address, company, name, score, source, action, etc.).

FIG. 6K shows illustrations of example conversational user interfaces. In some embodiments, the application generation module 314 (or the application development design hub 120) generates the conversational user interfaces 610K and 615K. For example, the conversational user interface 610K generates a first prompt for user information (e.g., “What new feature would you like added to your application?” 620K). A user may request the conversational user interface 610K to perform a specific first function (e.g., “Upload a csv of attendee information for my recent trade show” 621K). The conversational user interface 610K can then be configured to generate a status update on the requested first function (e.g., “Let me think about the best way to do that” 622K) and generate at least one recommendation for a user interface component (e.g., “I can recommend that we create a csv import feature which we will call Trade Show Attendee Import. We create a new table with the imported data and let's call that table Trade Show Attendee List. We'll input this feature in a new tab called Trade Show with icon” 623K) that is configured to provide the requested specific function. In some embodiments, the conversational user interface 610K requests that the user to upload one or more documents (e.g., 624K, 625K) for generating a customizable user interface element that performs the requested first function based on analyzing data associated with the one or more documents. Upon determining that the user has approved the at least one recommendation for the user interface component, the conversational user interface 610K regenerates the conversational user interface application as described earlier.

In some embodiments, the user can instruct the conversational user interface 610K to perform a second function (e.g., “Show an editable table of who registered for our Online seminars lately” 627K). In some embodiments, the second function is distinct from the first function. The conversational user interface 610K can then generate another user interface 615K for performing the requested second function. For example, the conversational user interface 610K generates the editable user interface 615K that has an editable table of persons that registered for the user's Online seminars recently. The editable table has a plurality of editable features (e.g., column 641A, type 642A, example values 643A, domain addresses 651K, type of business sector 660K, etc.) and can provide one or more directional instructions (e.g., “Here are our guesses about the different columns. Please fix any misunderstanding” 641K) for guiding the user about the editable features. The user interface 615K can have additional features for interacting with the user and enabling the import of additional data (e.g., “Import” 670K).

FIG. 6L shows an illustration of an example conversational user interface. In some embodiments, the application generation module 314 (or the application development design hub 120) generates conversational user interface 610L based on the requested first function and the at least one recommendation for the user interface component described above with respect to FIG. 6K. For example, the conversational user interface 610L has a new tab “Trade Show” 620L (described in 623K of FIG. 6K) with icon that has uploaded the csv file through the csv import feature “Trade Show Attendee Import”.

FIG. 6M shows an illustration of an example conversational user interface. In some embodiments, the application generation module 314 (or the application development design hub 120) generates a conversational user interface 600M that causes display of data associated with the uploaded csv document for the “Trade Show Attendee Import” feature described above with respect to FIG. 6L.

FIG. 6N shows illustrations of example conversational user interfaces with customizable application elements. In some embodiments, the application generation module 314 (or the application development design hub 120) generates a conversational user interface 610N and an editable user interface 630N associated with a requested user interface function for the conversational user interface 610N. For example, the conversational user interface 610N generates a prompt 620N requesting user instructions as described previously. The conversational user interface 610N receives one or more user instructions (e.g., “Merge the event attendees into my sales leads, noting duplicates. Put this in a new row in the Tradeshow tab. for adding features to the conversational user interface application.” 621N) that trigger a status notification (e.g., “Let me think about the best way to do that” 622N) during commencement of the analysis. The conversational user interface 610N then generates a plurality of recommendations (e.g., “I recommend that we create a Fuzzy matching feature, which we will call Event Attendees to Tradeshow Leads Merge. Among the tables in your app, let's make the source table Trade Show Attendee List and the destination Sales Leads. Let's map the source columns to destination columns like so: E-mail→email, Company→company, Industry→industry, Name→name, Lead Score→score, Event→source. Whenever two rows agree on these columns, we will mark them as duplicates: email, company. We'll put this feature in a new row in the existing tab Tradeshow” 623N) for regenerating the conversation user interface application.

In some embodiments, the conversational user interface 610N requests further user instructions for analyzing and providing the requested user interface function by generating a pop-up user interface 630N and requesting the user for instructions in a natural language format (e.g., “What mapping should we use instead?”). The user instructions can be associated with defining various data metrics (e.g., hierarchies, mapping, interconnectedness, etc.) for various types of data (e.g., e-mail 641N, company 642N, industry 643N, name 644N, score 645N, source 646N, etc.). The pop-up user interface is configured with user selectable features such as “Change” 651N and “Cancel” 655N for accepting, editing, changing, and/or canceling the presented user interface elements.

FIG. 6O shows an illustration of an example conversational user interface. In some embodiments, the application generation module 314 (or the application development design hub 120) generates a conversational user interface 610O that merges Trade Show attendees data with Sales Leads data through a fuzzy matching feature.

FIG. 6P shows an illustration of an example conversational user interface. In some embodiments, the application generation module 314 (or the application development design hub 120) generates a conversational user interface 610P that receives a user instruction to “Merge my sales leads data into salesforce, noting duplicates. Put it in a new tab” 621P. The conversational user interface 610P generates one or more recommendations (e.g., “I recommend that we create a Fuzzy matching feature, which we will call Salesforce Lead Integration. Among the tables in your app, let's make the source table Sales Leads and the destination Sales Leads. Let's map the source columns to destination columns like so: e-mail→Email, company→Account, name→Name Whenever two rows agree on these columns, we will mark them as duplicates: Email. We'll put this feature in a new tab called Salesforce Integration with icon” 623P) responsive to the user instruction for the user's approval. Upon receiving user approval (e.g., “This looks good. Regenerate my app!” 624P) for at least one recommendation of the one or more recommendations, the application generation module 314 (or the application development design hub 120) regenerates the user interface with newly added features corresponding to the user instruction for merging sales leads data into an integration tab, noting duplicates.

FIG. 6Q shows an illustration of an example conversational user interface. In some embodiments, the application generation module 314 (or the application development design hub 120) generates a conversational user interface 600Q that has the newly added features corresponding to the user instruction for merging sales leads data into the integration tab, noting duplicates described above with respect to FIG. 6P.

FIG. 6R shows an illustration of an example conversational user interface. In some embodiments, the application generation module 314 (or the application development design hub 120) generates a conversational user interface 610R that receives a user instruction Utility Application associated with presenting user data based on charts. For example, the user instruction requests presentation of “a dashboard tab with the following charts: how many leads from each industry, the lead with the top score from each industry, the average lead score by industry, the sum of lead scores by industry, and the sum of lead scores by source” 625R. In response to the user instruction, the application generation module 314 (or the application development design hub 120) generates one or more recommendations (e.g., “I recommend that we create a Graph from Query feature, which we will call Industry Lead Analytics Dashboard. We will make a Bar chart. I suggest that we retrieve the following data: from table Sales Leads, columns industry, count of email, maximum of score, average of score, sum of score. We'll put this feature in a new row in the existing tab Sales Leads” 635R) for user review. The user can accept, reject, or modify the one or more recommendations. In some embodiments, the user can provide additional instructions to refine the one or more recommendations through the conversational user interface 610R.

FIG. 6S shows an illustration of an example conversational user interface. In some embodiments, the application generation module 314 (or the application development design hub 120) generates a conversational user interface 610S that is responsive to the user instruction described with respect to FIG. 6R. For example, the generated conversational user interface 610S displays a dashboard tab 650S that has visual charts for data associated with company sectors 620S, 625S, 630S, leads by industry 635S, and maximum lead score by industry 645S. Thus, FIGS. 6A-6S illustrate example user interfaces and user interactions for generating applications using the systems and methods described herein.

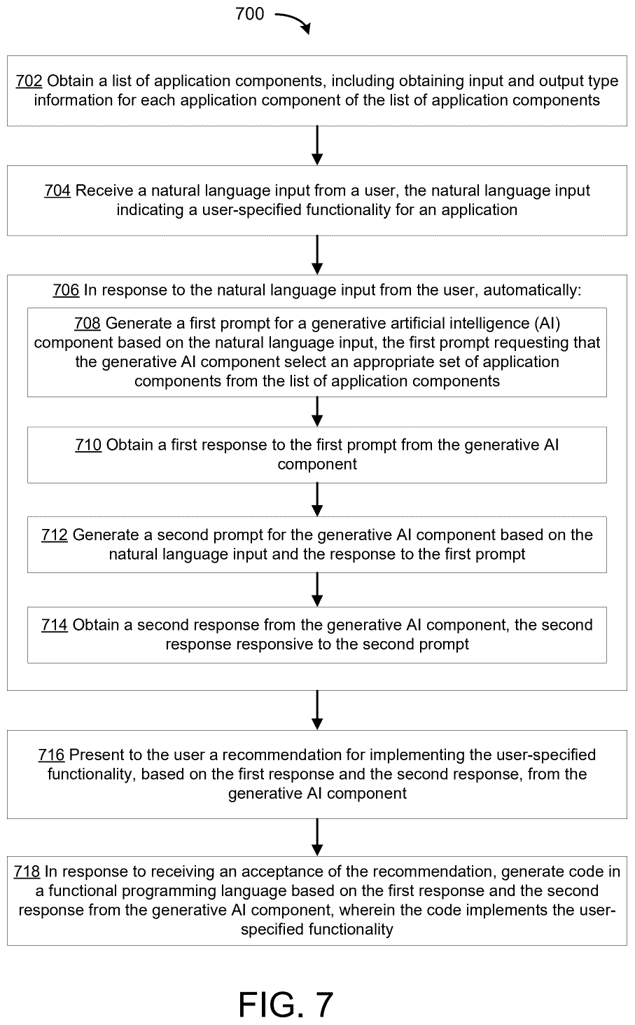

FIG. 7 is a flow diagram illustrating a method 700 of application generation in accordance with some embodiments. The method 700 may be performed at a computing system (e.g., the platform 100, the server system 115, and/or the client device 110) having control circuitry and memory storing instructions for execution by the control circuitry. In some embodiments, the method 700 is performed by executing instructions stored in memory (e.g., the memory 212 and/or the memory 306) of the computing system. In some embodiments, the method 700 is performed by a combination of a server system (e.g., the server system 115) and a client device (e.g., the client device 110). In some embodiments, the method 700 is performed by an application platform (e.g., a web-based application).

The system obtains (702) a list of pre-generated components, including obtaining input and output type information (e.g., data types such as strings, integers, floats, etc.) for each component of the list of pre-generated components (e.g., from data modules 240 and/or 330). In some embodiments, the pre-generated components are for use with generating and/or modifying applications. In some embodiments, the pre-generated components are coded using a functional programming language (e.g., the functional programming language 450).

The system receives (704) a natural language input (e.g., the input 660B, FIG. 6B) from a user, the natural language input indicating a user-specified functionality for an application. In some embodiments, the natural language input includes an indication of one or more documents and/or databases. In some embodiments, the natural language input comprises an audio input.

In response to the natural language input from the user (706), the system automatically (e.g., without further user input) generates (708) one or more prompts (e.g., via the prompt generation module 318) for a generative artificial intelligence (AI) component (e.g., the AI model(s) 150, FIG. 1) based on the natural language input and a decision tree. For example, a first prompt may request that the generative AI component select an appropriate set of components from the list of pre-generated components. As another example, a second prompt may indicate a configuration for the selected set of components.

The system obtains (710), from the generative AI component, respective responses to the one or more prompts. In some embodiments, each prompt is generated based on a decision tree and one or more prior responses from the AI component. In some embodiments, the system obtains a first response to the first prompt from the generative AI component.

The system repeats (712) the prompt generation based on the decision tree and prior response(s) until a full recommendation is generated from the respective response(s) from the generative AI component. For example, the system may generate a second prompt for the generative AI component based on the natural language input, the decision tree, and the response to the first prompt. As an example, the first prompt may be a request to identify appropriate functional components and the second prompt may be a request to identify appropriate configuration for the functional components identified in response to the first prompt.

In some embodiments, the system obtains (714) a second response from the generative AI component, the second response responsive to the second prompt. In some embodiments, the first prompt is provided to a first AI model (e.g., trained to select components) and the second prompt is provided to a second AI model (e.g., trained to configure components).

The system presents (716) to the user the full recommendation (e.g., the recommendation 675B, FIG. 6B) for implementing the user-specified functionality. In some embodiments, the full recommendation indicates selected components from the list of pre-generated components and configuration information for the selected components.

In response to receiving an acceptance of the recommendation, the system implements (718) the user-specified functionality using a subset of the pre-generated components. For example, the user interface 600C in FIG. 6C corresponds to the recommendation 675B in FIG. 6B.

Although FIG. 7 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

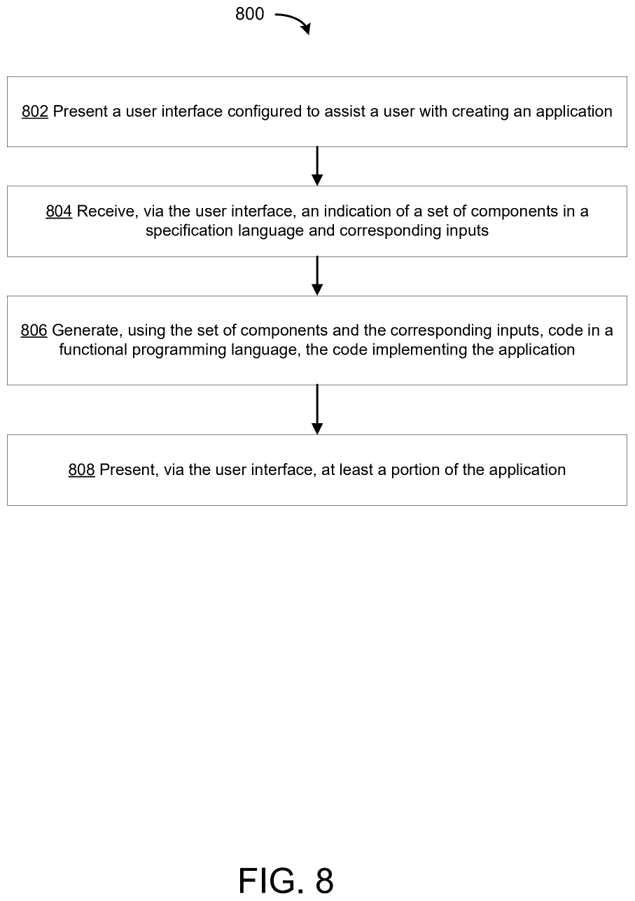

FIG. 8 is a flow diagram illustrating a method 800 of application generation in accordance with some embodiments. The method 800 may be performed at a computing system (e.g., the application development design hub 120, the server system(s) 115, and/or the client device 110) having control circuitry and memory storing instructions for execution by the control circuitry. In some embodiments, the method 800 is performed by executing instructions stored in memory (e.g., the memory 212 and/or the memory 306) of the computing system. In some embodiments, the method 800 is performed by a combination of an application development design hub (e.g., application development design hub 120), a server system (e.g., the server system(s) 115), and a client device (e.g., the client device 110). In some embodiments, the method 800 is performed by an application platform (e.g., a web-based application).

The system presents (802) a user interface (e.g., an instance of the various interfaces illustrated in FIGS. 6A-6S) configured to assist a user with creating an application. In some embodiments, the user interface comprises a chat interface in which a user may chat with an AI component (e.g., via an intermediary (prompt generation) component).

The system receives (804), via the user interface, an indication of a set of components in a specification language (e.g., corresponding to the specification language data 342) and corresponding inputs for the set of components (e.g., indicating how to connect/couple the set of components). For example, a natural language input is provided by a user.

The system generates (806), using the set of components and the corresponding inputs (e.g., configuration settings), code in a programming language (e.g., a functional programming language, using the functional programming data 344), the code implementing the application. In some embodiments, the code is generated via a specification language component (e.g., the specification language component 440).

The system presents (808), via the user interface, at least a portion of the application (e.g., via the user interface module 224, assistant module 222, and/or interface module 316). For example, the system presents a user interface of the application. In some embodiments, the user may interact with the user interface(s) of the application and then revise and/or deploy the application.

Although FIG. 8 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:

Some embodiments include a system (e.g., the system 100 in FIG. 1) for application development. The system includes: (i) a conversational user interface (e.g., the interface 410, FIG. 4) configured to interact with a user through natural-language dialogue; (ii) a decision-tree module (e.g., the application generation module 314, FIG. 4) configured to generate a sequence of prompts based on the natural-language dialogue and dynamically select subsequent prompts based on user responses; (iii) a prompt-engineering module (e.g., the prompt generation module 318) configured to generate specially engineered prompts for a language model based on the decision tree and available application components; (iv) a verification module (e.g., the specification language module 322) configured to apply formal program-verification techniques to ensure correctness and absence of security vulnerabilities in the generated application; and (v) a functional programming language module 324 that defines grammar and rules for generating code specifications, interfaces, protocols, and/or other information to ensure the application generation module 314 meets specifications for the client-requested application.

Some embodiments include a method for developing applications. The method includes (i) initiating a natural-language dialogue with a user through a conversational user interface (e.g., the interface 610, FIG. 6A); (ii) dynamically generating (e.g., via the prompt generation module 318) a sequence of prompts based on the natural-language dialogue and available application components; (iii) providing the sequence of prompts to a language model (e.g., the AI module 320) to generate portions of an application; (iv) applying formal program-verification techniques to the generated portions to ensure correctness and compliance with security policies (e.g., the specification language module 322); and (v) combining the verified portions to create the application (e.g., functional programming language module 324).

Some embodiments include a computer-implemented system (e.g., the system 100) for secure application development. The system includes: (i) a language model (e.g., a language model 224) configured to generate application code based on specially engineered prompts; a prompt-engineering module configured to generate the specially engineered prompts based on a natural-language dialogue with a user, a decision tree, and available application components; (ii) a policy module (e.g., a subcomponent of the assistant module 222 or the application generation module 314) configured to incorporate policy documents into the specially engineered prompts to ensure compliance with security and data-usage policies; and (iii) a verification module (e.g., a subcomponent of the assistant module 222 or the application generation module 314) configured to analyze information flow in the generated application code and verify the absence of security vulnerabilities and data leaks.

Some embodiments include a system for application development. The system includes: (i) a conversational user interface (e.g., generated via interface modules 224 and/or Utility Application 316) adapted to receive user input in natural language (e.g., as illustrated in FIGS. 6A-6S); (ii) a decision-tree engine (e.g., the prompt modules 226 and/or 318) configured to dynamically generate a sequence of questions based on user input and system capabilities; (iii) a component library (e.g., coding libraries 244 and/or 334) comprising components encapsulating business logic and data access; (iv) a generative AI module (e.g., the AI modules 228 and/or 320) configured to interact with the decision-tree engine and component library to guide the user through an interactive application development process; and (v) a program-verification module (e.g., the specification modules 230 and/or 322) adapted to verify the correctness and security of the generated application based on a simplified programming language subset.

Some embodiments include a method for application development using a conversational user interface. The method includes: (i) receiving user input in natural language describing a desired application functionality; (ii) dynamically generating a series of follow-up questions based on the user input and a decision tree; (iii) guiding the user through an interactive dialogue to refine their application requirements; and (iv) generating prompts for a large language model (LLM) to select appropriate pre-built components based on the user's responses.

Some embodiments include a method for developing applications using a large language model (LLM). The method includes: (i) receiving user input describing a desired application functionality; (ii) engineering prompts for the LLM that include user input and descriptions of available components; (iii) querying the LLM to select components and generate code snippets based on the prompts; and (iv) verifying the generated code for correctness and adherence to security policies.

Some embodiments include a method for application development with automatic security verification. The method includes: (i) generating an application using a simplified programming language subset; (ii) analyzing the generated application to determine information flow; and (iii) automatically verifying that the information flow complies with specified security policies.

(A1) In one aspect, some embodiments include a method of application generation that includes: (i) obtaining a list of application components, including obtaining input and output type information for each application component of the list of application components; (ii) receiving a natural language input from a user, the natural language input indicating a user-specified functionality for an application; (iii) in response to the natural language input from the user, automatically: (a) generating a first prompt for a generative artificial intelligence (AI) component based on the natural language input, the first prompt requesting that the generative AI component select an appropriate set of application components from the list of application components; (b) obtaining a first response to the first prompt from the generative AI component; (c) generating a second prompt for the generative AI component based on the natural language input and the response to the first prompt; and (d) obtaining a second response from the generative AI component, the second response responsive to the second prompt; (iv) presenting to the user a recommendation for implementing the user-specified functionality, based on the first response and the second response, from the generative AI component; and (v) in response to receiving an acceptance of the recommendation, generating code in a (e.g., functional) programming language based on the first response and the second response from the generative AI component, wherein the code implements the user-specified functionality.

(B1) In one aspect, some embodiments include a method of application generation that includes: (i) presenting a user interface configured to assist a user with creating an application; (ii) receiving, via the user interface, an indication of a set of components in a specification language and corresponding inputs (e.g., configuration settings); (iii) generating, using the set of components and the corresponding inputs, code in a (e.g., functional) programming language, the code implementing the application; and (iv) presenting, via the user interface, at least a portion of the application. For example, the programming language may be Ur/Web. In some embodiments, the user interface provides a no-code application development platform. For example, the user interface enables users to generate applications without requiring any knowledge of the functional programming language (or coding knowledge in general).

(B2) In some embodiments of B1, the programming language has an expressive static-type system. For example, the programming language consists of expressive functional components (e.g., which are verifiable at compile time). In some embodiments, the functional programming language is a strongly-typed language. In some embodiments, the functional programming language is a Turing-complete language.

(B3) In some embodiments of B1 or B2, the specification language corresponds to a simplified subset of the programming language. In some embodiments, the specification language is a strongly-typed language. In some embodiments, the specification language does not include any functions. For example, the specification language is a declarative language. As an example, the specification may be used to choose and configure predefined components. In some embodiments, the specification language is not a Turing-complete language.

(B4) In some embodiments of B3, the specification language comprises functionality for configuring and connecting the set of components. In some embodiments, the specification language does not include functionality for implementing the set of components. In some embodiments, the specification language is inherently sound (e.g., trustworthy). For example, if the generated code compiles, then the application is guaranteed to execute properly.

(B5) In some embodiments of any of B1-B4, the user interface is configured to adhere to expressive type information of the programming language while generating the code implementing the application. For example, the user interface restricts users from generating ill-formed code for the application.

(B6) In some embodiments of any of B1-B5, the user interface comprises a set of predefined input fields, and wherein the indication of the set of components and the corresponding inputs are received via the set of predefined input fields. For example, the user interface may include a variety of buttons, drop-down menus, and other types of input fields to guide the user's identification of desired functionality. In some embodiments, the user interface includes a set of graphical user interface (GUI) widgets.

(B7) In some embodiments of any of B1-B6, the set of components correspond to a set of predefined functions in the programming language. In some embodiments, the set of components correspond to one or more libraries and/or frameworks in the programming language. For example, the set of predefined functions may include an SQL query function, a CSV import function, a fuzzy matching function, a data translation function, and/or other type of function.

(B8) In some embodiments of any of B1-B7, the method further includes, after generating the code in the programming language, generating one or more binaries by compiling the generated code. For example, the one or more binaries are generated using a compiler (e.g., a compiler that is configured to optimize functionality at a whole-program level). The compiler may be configured to produce scalable binaries based on the user inputs.

(B9) In some embodiments of any of B1-B8, the set of components comprises one or more functional components and one or more connector components. In some embodiments, the connector components are configured to import data from one or more sources (e.g., relational databases, object databases, document databases, customer relationship management (CRM) data sources, enterprise resource planning (ERP) data sources, and/or other types of sources). In some embodiments, at least a subset of the connector components are configured to obtain data from third-party sources.

(B10) In some embodiments of any of B1-B9, the method further includes storing the application in a storage location specified by the user.

(B11) In some embodiments of any of B1-B10, the application comprises one or more of: a business process automation application, a reporting and analysis application, a systems integration application, an employee/customer portal application, an automated data flow application, and a web-based application.

(B12) In some embodiments of any of B1-B11, generating the code in the programming language comprises verifying that the generated code complies with one or more policies. For example, the verification may check information flow to determine whether particular information (e.g., sensitive information such as personal identifiable information (PII)) may appear as output. In some embodiments, verifying that the generated code complies with the one or more policies comprises determining that certain approval/authentication processes are implemented in the generated code. As an example, the one or more policies may include one or more security policies and/or one or more compliance policies. As an example, the one or more policies may be specified by the user and/or an organization that employs the user. In some embodiments, the one or more policies comprise a set of rules for the generated code.

(B13) In some embodiments of any of B1-B12, the method further includes: (i) after generating the code in the programming language, receiving a rule and a request to verify whether the generated code complies with the rule; (ii) verifying, using the specification language, whether the generated code complies with the rule; and (iii) presenting information about the verification. For example, a program analysis tool ingests the specification language to answer questions about the generated code (e.g., security questions and/or compliance questions). In some embodiments, the rule and request are received from the user. In some embodiments, the rule and request are received from another user (e.g., in the same organization). In some embodiments, the rule and request are received via the user interface. In some embodiments, the information about the verification is presented via the user interface. In some embodiments, the information about the verification includes identification of a violation of the rule and one or more suggestions for addressing the violation.

(B14) In some embodiments of any of B1-B13, the user interface includes a text entry field, and wherein the indication of the set of components is received via the text entry field. For example, the user interface includes a chat bot (e.g., a chat box in which the user may interact with a digital assistant).

(B15) In some embodiments of any of B1-B14, the indication of the set of components is obtained from a natural language input from the user. For example, the user inputs a natural language description of the desired functionality and the indication of the set of components is identified from the natural language description. In some embodiments, the natural language input comprises a text input and/or a spoken word input.

(B16) In some embodiments of B15, the natural language input is provided to a generative artificial intelligence (AI) component, and the generative AI component is configured to identify the set of components from the natural language input. In some embodiments, the generative AI component is not trained based on the programming language or the specification language. For example, the generative AI component is a general-purpose chatbot (e.g., such as Chat GPT, Gemini, or Pi). In some embodiments, the natural language input is provided to one or more machine learning models (e.g., generative adversarial networks, neural networks, transformers, and/or natural language interfaces). In some embodiments, the generative AI component comprises one or more large language models (LLMs).

(B17) In some embodiments of B16, the natural language input is provided to the generative AI component along with one or more prompt instructions that restrict the generative AI component to providing identification of the set of components and the corresponding inputs. For example, the one or more prompt instructions instruct the AI component to identify the set of Utility Application components from a predefined list of components (and/or indicate that no component is applicable).

(B18) In some embodiments of B17, the natural language input is translated to a set of two or more prompts that are provided to the generative AI component. For example, the natural language input may correspond to a request to generate a graph using data from a comma separated value (CSV) file. In this example, the AI component may first be prompted to identify the set of components from a predefined set of components. In response to the AI component identifying the set of components, the AI component may then be prompted to identify which data in the CSV should be used for the graph. Next, the AI component may be prompted to identify a display option for the graph from a predefined set of display options. In this example, the series of prompts is not known to (e.g., not generated by or presented to) the user.

(B19) In some embodiments of B18, the natural language input is translated to the set of two or more prompts using a (predefined) decision tree (e.g., an answer from the AI component at one level determines what the next prompt should be). In some embodiments, the decision tree is constructed based on the type structure of the specification language. In some embodiments, the decision tree is constructed to comply with one or more policies (e.g., security policies, compliance policies, human resources policies, and/or other types of policies or rules). In some embodiments, a sequence of prompts is generated using the decision tree and previously received information (e.g., prior prompts and/or corresponding outputs). For example, a decision tree may be selected based on the initial natural language input. In this example, the decision tree may be traversed until the system (e.g., the AI component) has sufficient information to implement the user-specified functionality. As a specific example, the decision tree may be used to select the appropriate predefined components and then configure and/or connect the selected components (e.g., to one another and/or to external data sources). The decision may indicate what additional information may need to be obtained from the user to complete each step in the process.

(B20) In some embodiments of any of B16-B19, the generative AI component is provided with a predefined list of components in the specification language, and the predefined list of components includes respective input, output, and type information for each component.

In another aspect, some embodiments include a computing system including one or more processors and memory coupled to the one or more processors, the memory storing one or more programs configured to be executed by the one or more processors, the one or more programs including instructions for performing any of the methods described herein (e.g., the methods 700 and 800, A1, and B1-B20 above).

In yet another aspect, some embodiments include a non-transitory computer-readable storage medium storing one or more programs for execution by one or more processors of a computing system, the one or more programs including instructions for performing any of the methods described herein (e.g., the methods 700 and 800, A1, and B1-B20 above).

Various types of models and algorithms may be used with the systems and components disclosed herein. In some embodiments, a model is a supervised machine learning algorithm. Nonlimiting examples of supervised learning algorithms include, but are not limited to, logistic regression, neural networks, support vector machines, Naive Bayes algorithms, nearest neighbor algorithms, random forest algorithms, decision tree algorithms, boosted trees algorithms, multinomial logistic regression algorithms, linear models, linear regression, GradientBoosting, mixture models, hidden Markov models, Gaussian NB algorithms, linear discriminant analysis, or any combinations thereof. In some embodiments, a model is a multinomial classifier algorithm. In some embodiments, a model is a 2-stage stochastic gradient descent (SGD) model. In some embodiments, a model is a deep neural network (e.g., a deep-and-wide sample-level classifier). In some embodiments, a model is, or includes, a neural network (e.g., a convolutional neural network and/or a residual neural network). In some embodiments, a model is, or includes, a Naive Bayes algorithm. In some embodiments, a model is, or includes, a support vector machine (SVM). In some embodiments, a model is, or includes, a nearest neighbor algorithm. In some embodiments, a model is, or includes, a decision tree. In some embodiments, the decision tree model includes at least 10, at least 20, at least 50, or at least 100 parameters (e.g., weights and/or decisions) and requires a computer to calculate because it cannot be mentally solved. In some embodiments, a model is a reinforcement learning model. In some embodiments, a model uses a regression algorithm. In some embodiments, an ensemble (e.g., two or more) of models is used.

As an example, a variety of neural networks may be suitable for use in analyzing natural language and text. Examples can include, but are not limited to, feedforward neural networks, radial basis function networks, recurrent neural networks, residual neural networks, convolutional neural networks, residual convolutional neural networks, and the like, or any combination thereof. In some embodiments, a machine-learning model uses a pre-trained and/or transfer-learned ANN or deep learning architecture. Convolutional and/or residual neural networks can be used for analyzing an image of a subject in accordance with the present disclosure.

A deep neural network model may include an input layer, a plurality of individually parameterized (e.g., weighted) convolutional layers, and an output scorer. The parameters (e.g., weights) of each of the convolutional layers as well as the input layer contribute to the plurality of parameters (e.g., weights) associated with the deep neural network model. In some embodiments, at least 100 parameters, at least 1000 parameters, at least 2000 parameters or at least 5000 parameters are associated with the deep neural network model. In some embodiments, the deep neural network uses a larger number of parameters such as 1 million parameters, 1 billion parameters, or 100 billion parameters. As such, deep neural network models require a computer to be used because they cannot be mentally solved. In other words, given an input to the model, the model output needs to be determined using a computer rather than mentally in such embodiments.

As used herein, the term “instruction” refers to an order given to a computer processor by a computer program. On a digital computer, in some embodiments, each instruction is a sequence of 0's and 1's that describes a physical operation the computer is to perform. Such instructions can include data transfer instructions and data manipulation instructions. In some embodiments, each instruction is a type of instruction in an instruction set that is recognized by a particular processor type used to carry out the instructions. Examples of instruction sets include, but are not limited to, Reduced Instruction Set Computer (RISC), Complex Instruction Set Computer (CISC), Minimal Instruction Set Computers (MISC), Very Long Instruction Word (VLIW), Explicitly Parallel Instruction Computing (EPIC), and One Instruction Set Computer (OISC).

As used herein, the term “parameter” refers to any coefficient or, similarly, any value of an internal or external element (e.g., a weight and/or a hyperparameter) in an algorithm, model, regressor, and/or classifier that can affect (e.g., modify, tailor, and/or adjust) one or more inputs, outputs, and/or functions in the algorithm, model, regressor and/or classifier. For example, in some embodiments, a parameter refers to any coefficient, weight, and/or hyperparameter that can be used to control, modify, tailor, and/or adjust the behavior, learning, and/or performance of an algorithm, model, regressor, and/or classifier. In some instances, a parameter is used to increase or decrease the influence of an input (e.g., a feature) to an algorithm, model, regressor, and/or classifier. As a nonlimiting example, in some embodiments, a parameter is used to increase or decrease the influence of a node (e.g., of a neural network), where the node includes one or more activation functions. Assignment of parameters to specific inputs, outputs, and/or functions is not limited to any one paradigm for a given algorithm, model, regressor, and/or classifier but can be used in any suitable algorithm, model, regressor, and/or classifier architecture for a desired performance. In some embodiments, a parameter has a fixed value. In some embodiments, a value of a parameter is manually and/or automatically adjustable. In some embodiments, a value of a parameter is modified by a validation and/or training process for an algorithm, model, regressor, and/or classifier (e.g., by error minimization and/or backpropagation methods). In some embodiments, an algorithm, model, regressor, and/or classifier of the present disclosure includes a plurality of parameters. As such, the algorithms, models, regressors, and/or classifiers of the present disclosure cannot be mentally performed. In some embodiments, the algorithms, models, regressors, and/or classifier of the present disclosure operate in a k-dimensional space, where k is a positive integer of 5 or greater (e.g., 5, 6, 7, 8, 9, 10, etc.). As such, the algorithms, models, regressors, and/or classifiers of the present disclosure cannot be mentally performed.

In some embodiments, the methods described herein include inputting information into a model comprising a plurality of parameters, where the model applies the plurality of parameters to the information through a plurality of instructions to generate an output from the model.

In some embodiments, an algorithm, model, regressor, and/or classifier of the present disclosure comprises a plurality of parameters. In some embodiments the plurality of parameters is n parameters, where: n≥2; n≥5; n≥10; n≥25; n≥40; n≥50; n≥75; n≥100; n≥125; n≥150; n≥200; n≥225; n≥250; n≥350; n≥500; n≥600; n≥750; n≥1,000; n≥2,000; n≥4,000; n≥5,000; n≥7,500; n≥10,000; n≥20,000; n≥40,000; n≥75,000; n≥100,000; n≥200,000; n≥500,000, n≥1×10⁶, n≥5×10⁶, or n≥1×10⁷. In some embodiments n is between 10,000 and 1×10⁷, between 100,000 and 5×10⁶, or between 500,000 and 1×10⁶. In some embodiments, the plurality of parameters is at least 1000 parameters, at least 5000 parameters, at least 10,000 parameters, at least 50,000 parameters, at least 100,000 parameters, at least 250,000 parameters, at least 500,000 parameters, at least 1 million parameters, at least 5 million parameters, at least 10 million parameters, at least 25 million parameters, at least 50 million parameters, at least 100 million parameters, at least 250 million parameters, at least 500 million parameters, at least 1 billion parameters, or more parameters.

In some embodiments, the plurality of instructions is at least 1000 instructions, at least 5000 instructions, at least 10,000 instructions, at least 50,000 instructions, at least 100,000 instructions, at least 250,000 instructions, at least 500,000 instructions, at least 1 million instructions, at least 5 million instructions, at least 10 million instructions, at least 25 million instructions, at least 50 million instructions, at least 100 million instructions, at least 250 million instructions, at least 500 million instructions, at least 1 billion instructions, or more instructions.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be understood that, although the terms “first,” “second,” etc. may be used herein to describe various elements, these elements should not be limited by these terms. These terms are only used to distinguish one element from another.

As used herein, the term “set” refers to a group of one or more objects. As used herein, the terms “request,” “prompt,” and “query” are used interchangeable unless expressly stated otherwise. As used herein, the term “model” refers to a machine learning model or algorithm. In some embodiments, the model is a task-specific model (e.g., a task-specific machine-learning model). As used herein, the term “task-specific” refers to a component that is specifically configured to perform a single task or a subset of tasks (e.g., a single class of tasks). In some embodiments, the model is an unsupervised learning algorithm. One example of an unsupervised learning algorithm is cluster analysis.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of application generation, the method comprising:
obtaining information about a set of pre-generated components for application generation, including obtaining input and output type information for each component of the set of pre-generated components;
receiving a natural language input from a user, the natural language input indicating a user-specified functionality for an application;
in response to the natural language input from the user, automatically:
generating a first prompt for a generative artificial intelligence (AI) component based on the natural language input, the first prompt requesting that the generative AI component select an appropriate set of components from the set of pre-generated components;
obtaining a first response to the first prompt from the generative AI component;
generating a second prompt for the generative AI component based on the natural language input and the response to the first prompt; and
obtaining a second response from the generative AI component, the second response responsive to the second prompt;
presenting to the user a recommendation for implementing the user-specified functionality, based on the first response and the second response from the generative AI component, the recommendation corresponding to a subset of the set of pre-generated components; and
in response to receiving an acceptance of the recommendation, implementing the user-specified functionality using the subset of the pre-generated components.

2. The method of claim 1, wherein the information about the set of pre-generated components for application generation comprises a specification language.

3. The method of claim 2, wherein the user-specified functionality is implemented using a programming language, and wherein the specification language corresponds to a simplified subset of the programming language.

4. The method of claim 3, wherein the set of pre-generated components corresponds to a set of predefined functions in the programming language.

5. The method of claim 1, wherein the set of pre-generated components comprises one or more functional components and one or more connector components.

6. The method of claim 1, further comprising verifying that the recommendation for implementing the user-specified functionality complies with one or more policies.

7. The method of claim 1, wherein the second prompt is generated using a predefined decision tree.

8. A computing system, comprising:
control circuitry;
memory; and
one or more sets of instructions stored in the memory and configured for execution by the control circuitry, the one or more sets of instructions comprising instructions for:
obtaining information about a set of pre-generated components for application generation, including obtaining input and output type information for each component of the set of pre-generated components;
receiving a natural language input from a user, the natural language input indicating a user-specified functionality for an application;
in response to the natural language input from the user, automatically:
generating a first prompt for a generative artificial intelligence (AI) component based on the natural language input, the first prompt requesting that the generative AI component select an appropriate set of components from the set of pre-generated components;
obtaining a first response to the first prompt from the generative AI component;
generating a second prompt for the generative AI component based on the natural language input and the response to the first prompt; and
obtaining a second response from the generative AI component, the second response responsive to the second prompt;
presenting to the user a recommendation for implementing the user-specified functionality, based on the first response and the second response from the generative AI component, the recommendation corresponding to a subset of the set of pre-generated components; and
in response to receiving an acceptance of the recommendation, implementing the user-specified functionality using the subset of the pre-generated components.

9. The computing system of claim 8, wherein the information about the set of pre-generated components for application generation comprises a specification language.

10. The computing system of claim 9, wherein the user-specified functionality is implemented using a programming language, and wherein the specification language corresponds to a simplified subset of the programming language.

11. The computing system of claim 10, wherein the set of pre-generated components corresponds to a set of predefined functions in the programming language.

12. The computing system of claim 8, wherein the set of pre-generated components comprises one or more functional components and one or more connector components.

13. The computing system of claim 8, wherein the one or more sets of instructions further comprise instructions for verifying that the recommendation for implementing the user-specified functionality complies with one or more policies.

14. The computing system of claim 8, wherein the second prompt is generated using a predefined decision tree.

15. A non-transitory computer-readable storage medium storing one or more sets of instructions configured for execution by a computing system having control circuitry and memory, the one or more sets of instructions comprising instructions for:
obtaining information about a set of pre-generated components for application generation, including obtaining input and output type information for each component of the set of pre-generated components;
receiving a natural language input from a user, the natural language input indicating a user-specified functionality for an application;
in response to the natural language input from the user, automatically:
generating a first prompt for a generative artificial intelligence (AI) component based on the natural language input, the first prompt requesting that the generative AI component select an appropriate set of components from the set of pre-generated components;
obtaining a first response to the first prompt from the generative AI component;
generating a second prompt for the generative AI component based on the natural language input and the response to the first prompt; and
obtaining a second response from the generative AI component, the second response responsive to the second prompt;
presenting to the user a recommendation for implementing the user-specified functionality, based on the first response and the second response from the generative AI component, the recommendation corresponding to a subset of the set of pre-generated components; and
in response to receiving an acceptance of the recommendation, implementing the user-specified functionality using the subset of the pre-generated components.

16. The non-transitory computer-readable storage medium of claim 15, wherein the information about the set of pre-generated components for application generation comprises a specification language.

17. The non-transitory computer-readable storage medium of claim 16, wherein the user-specified functionality is implemented using a programming language, and wherein the specification language corresponds to a simplified subset of the programming language.

18. The non-transitory computer-readable storage medium of claim 17, wherein the set of pre-generated components corresponds to a set of predefined functions in the programming language.

19. The non-transitory computer-readable storage medium of claim 15, wherein the set of pre-generated components comprises one or more functional components and one or more connector components.

20. The non-transitory computer-readable storage medium of claim 15, wherein the second prompt is generated using a predefined decision tree.
